(19) United States
(12) Patent Application Publication
(10) Pub. No.: US 2025/0294412 A1
(43) Pub. Date: Sep. 18, 2025

(54) ELECTRONIC DEVICE AND METHOD FOR PERFORMING CELL MIGRATION OF DISTRIBUTED UNIT

(71) Applicant: Samsung Electronics Co., Ltd., Suwon-si (KR)

(72) Inventor: Daejoong KIM, Suwon-si (KR)

(21) Appl. No.: 19/217,698

(22) Filed: May 23, 2025

Related U.S. Application Data
(63) Continuation of application No. PCT/KR2023/015366, filed on Oct. 5, 2023.

(30) Foreign Application Priority Data
Nov. 25, 2022 (KR) 10-2022-0160971
Dec. 29, 2022 (KR) 10-2022-0189918

(51) Int. Cl. H04W 36/00; H04L 5/00

(52) U.S. Cl. CPC H04W 36/0022; H04L 5/0053; H04W 36/0033; H04W 36/0061

(57) ABSTRACT

A method performed by a centralized-radio access network (C-RAN) hub device in a wireless communication system is provided. The method includes transmitting a request message for moving a function for a cell of a distributed unit (DU) connected to the C-RAN hub device, based on the request message reallocating at least one of a packet distributing pod (PDP) function of the DU for a radio link control (RLC) layer or a baseband processing pod (BPP) function for a medium access control (MAC) layer, and based on the reallocation, performing at least one of the PDP function of the DU and the BPP function of the DU.

### CROSS-REFERENCE TO RELATED APPLICATION(S)

This application is a continuation application, claiming priority under 35 U.S.C. § 365(c), of an International application No. PCT/KR2023/015366, filed on Oct. 5, 2023, which is based on and claims the benefit of a Korean patent application number 10-2022-0160971, filed on Nov. 25, 2022, in the Korean Intellectual Property Office, and of a Korean patent application number 10-2022-0189918, filed on Dec. 29, 2022, in the Korean Intellectual Property Office, the disclosure of each of which is incorporated by reference herein in its entirety.

### BACKGROUND

### 1. Field

The disclosure relates to an electronic device and a method for performing cell migration of a distributed unit (DU).

### 2. Description of Related Art

4^{th} generation (4G) mobile communication network and 5^{th} generation (5G) mobile communication network may be established in a distributed-radio access network (D-RAN) method. For example, in the D-RAN, each base station (gNB) may include an antenna, a radio unit (RU), and a distributed unit (DU). Functions of a packet data convergence protocol (PDCP) layer, a radio link control (RLC) layer, a medium access control (MAC) layer, and a physical (PHY) layer may be performed in the DU.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for performing cell migration of a distributed unit (DU).

Additional aspects will be set forth in part in the description which follows and, in part, will be apparent from the description, or may be learned by practice of the presented embodiments.

In accordance with an aspect of the disclosure, a method performed by a centralized-radio access network (C-RAN) hub device in a wireless network system is provided. The method includes transmitting a request message for function transfer for a cell of a distributed unit (DU) connected to the C-RAN hub device, based on the request message, relocating at least one of a packet distributing pod (PDP) function for a radio link control (RLC) layer or a baseband processing pod (BPP) function for a medium access control (MAC) layer, to the C-RAN hub device, and based on the relocation, performing at least one of the PDP function of the DU or the BPP function of the DU.

In accordance with another aspect of the disclosure, a method performed by a distributed unit (DU) is provided. The method includes receiving, from a centralized-radio access network (C-RAN) hub device connected to the DU, a request message for cell migration of the DU, wherein the request message includes cell identification information, transmitting, to the C-RAN hub device, a bearer handover request message for relocating a packet distributing pod (PDP) function for a radio link control (RLC) layer of the DU, receiving a bearer handover acknowledgement message from the C-RAN hub device, transmitting, to the C-RAN hub device, a baseband handover request message for relocating a baseband processing pod (BPP) function for a medium access control (MAC) protocol of the DU, receiving, from the C-RAN hub device, a baseband handover response message, wherein the bearer handover request message includes context information on the RLC layer and the cell identification information, and wherein the baseband handover request message includes context information on the MAC layer and the cell identification information.

In accordance with another aspect of the disclosure, a centralized-radio access network (C-RAN) hub device in a wireless network system is provided. The C-RAN hub device includes memory, a transceiver, and at least one processor, wherein the at least one processor is configured to transmit a request message for function transfer for a cell of a distributed unit (DU) connected to the C-RAN hub device, based on the request message for function transfer for the cell, relocate at least one of a packet distributing pod (PDP) function for a radio link control (RLC) layer or a baseband processing pod (BPP) function for a medium access control (MAC) layer, to the C-RAN hub device, based on the relocation, perform at least one of the PDP function of the DU or the BPP function of the DU.

In accordance with another aspect of the disclosure, an electronic device performed by a distributed unit (DU) in a wireless network system is provided. The electronic device includes memory, a transceiver, and at least one processor, wherein the at least one processor is configured to receive, from a centralized-radio access network (C-RAN) hub device connected to the DU, a request message for cell migration of the DU, wherein the request message includes cell identification information, transmit, to the C-RAN hub device, a bearer handover request message for relocating a packet distributing pod (PDP) function for a radio link control (RLC) layer of the DU. The at least one processor may be configured to receive a bearer handover acknowledgement message from the C-RAN hub device. The at least one processor may be configured to transmit, to the C-RAN hub device, a baseband handover request message for relocating a baseband processing pod (BPP) function for a medium access control (MAC) protocol of the DU, receive, from the C-RAN hub device, a baseband handover response message, wherein the bearer handover request message includes context information on the RLC layer and the cell identification information, and wherein the baseband handover request message includes context information on the MAC layer and the cell identification information.

In accordance with another aspect of the disclosure, one or more non-transitory computer readable storage media storing one or more computer-readable programs including computer-executable instructions that, when executed by one or more processors of a centralized-radio access network (C-RAN) hub device individually or collectively, cause the C-RAN hub device to perform operations is provided. The operations include transmitting a request message for function transfer for a cell of a distributed unit (DU) connected to the C-RAN hub device, based on the request message, relocating at least one of a packet distributing pod (PDP) function for a radio link control (RLC) layer or a baseband processing pod (BPP) function for a medium access control (MAC) layer, to the C-RAN hub device, based on the relocation, performing at least one of the PDP function of the DU or the BPP function of the DU.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, and 1C illustrate an example of distributed-radio access network (D-RAN), centralized-RAN (C-RAN), and hybrid-RAN (H-RAN) structures according to various embodiments of the disclosure;

FIGS. 2A and 2B illustrate an example of H-RAN structure according to various embodiments of the disclosure;

FIG. 3 illustrates an example of cell migration operation in a virtualized RAN according to an embodiment of the disclosure;

FIG. 4 illustrates an example of a cell load information collection and a cell migration (CM) determination operation and a CM preparation operation, according to an embodiment of the disclosure;

FIG. 5 illustrates an example of an operation for a CM when a load of a cell is reduced, according to an embodiment of the disclosure;

FIG. 6 illustrates an example of a CM preparation operation according to an embodiment of the disclosure;

FIG. 7 illustrates an example of a CM preparation operation according to an embodiment of the disclosure;

FIG. 8 illustrates an example of a packet distributing pod (PDP) relocation operation according to an embodiment of the disclosure;

FIG. 9 illustrates an example of a baseband processing pod (BPP) relocation operation according to an embodiment of the disclosure;

FIG. 10A is a flowchart illustrating an operation of a C-RAN hub device according to an embodiment of the disclosure;

FIG. 10B is a flowchart illustrating an operation of a C-RAN hub device according to an embodiment of the disclosure;

FIG. 11 is a flowchart illustrating an operation of a distributed unit (DU) according to an embodiment of the disclosure;

FIG. 12 illustrates a functional configuration of an electronic device according to an embodiment of the disclosure;

FIG. 13 illustrates a wireless communication system according to an embodiment of the disclosure;

FIG. 14A illustrates an example of a control plane (C-plane) according to an embodiment of the disclosure; and

FIG. 14B illustrates an example of a user plane (U-plane) according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms used in the disclosure are used only to describe a specific embodiment, and may not be intended to limit a range of another embodiment. Terms used herein, including a technical or a scientific term, may have the same meaning as those generally understood by a person with ordinary skill in the art described in the disclosure. Among the terms used in the disclosure, terms defined in a general dictionary may be interpreted as identical or similar meaning to the contextual meaning of the relevant technology and are not interpreted as ideal or excessively formal meaning unless explicitly defined in the disclosure. In some cases, even terms defined in the disclosure may not be interpreted to exclude embodiments of the disclosure.

In various embodiments of the disclosure described below, a hardware approach will be described as an example. However, since the various embodiments of the disclosure include technology that uses both hardware and software, the various embodiments of the disclosure do not exclude a software-based approach.

Terms referring to signal (e.g. packet, message, signal, information, signaling), terms referring to resource (e.g. section, symbol, slot, subframe, radio frame, subcarrier, resource element (RE), resource block (RB), bandwidth part (BWP), occasion), terms for operational state (e.g. step, operation, procedure), terms referring to data (e.g. packet, message, user stream, information, bit, symbol, codeword), terms referring to channel, terms referring to network entities (e.g., distributed unit (DU), radio unit (RU), central unit (CU), CU-control plane (CP), CU-user plane (UP), open radio access network (O-RAN)-DU (O-DU), O-RAN RU (O-RU), O-RAN CU (O-CU), O-RAN CU-CP (O-CU-UP), O-RAN CU-CP (O-CU-CP)), terms referring to component of a device, which are used in the following description are exemplified for convenience of explanation. Therefore, the disclosure is not limited to terms to be described below, and another term having an equivalent technical meaning may be used. In addition, a term such as ‘ . . . unit,’ . . . device, ‘ . . . object’, and ‘ . . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

Although the disclosure describes various embodiments using terms used in some communication standards (e.g., 3rd Generation Partnership Project (3GPP), extensible radio access network (xRAN), open-radio access network (O-RAN)), these are only examples for explanation. The various embodiments of the disclosure may be easily modified and applied to other communication systems.

According to an embodiment, 4^{th} generation (4G) mobile communication network and 5^{th} generation (5G) mobile communication network may be established in a distributed-RAN (D-RAN) method. For example, in D-RAN, each base station (gNB) may include an antenna, a radio unit (RU), and a distributed unit (DU). Functions of a packet data convergence protocol (PDCP) layer (hereinafter, PDCP), a radio link control (RLC) layer (hereinafter, RLC), a medium access control (MAC) layer (hereinafter, MAC), and a physical (PHY) layer (hereinafter, PHY) may be performed in the DU. According to an embodiment, when function split is applied, functions of RLC, MAC, and PHY may be performed in the DU. A function of PDCP may be performed in a centralized unit (CU) independent of the DU. A device for the CU (or a device performed by the CU) that includes the function of PDCP may be deployed in a centralized-RAN (C-RAN) hub or a central office. For example, in the C-RAN, an antenna and RU are deployed at each base station, and DU performing baseband processing may be deployed in the C-RAN Hub. The C-RAN Hub may be established within a specified distance (e.g., up to 30 km to 50 km) from the RU for real-time processing of the RAN.

According to an embodiment, in the D-RAN, the DU may be installed at maximum capacity in consideration of a case in which the maximum number of UEs capable of being processed by a base station are connected to the base station or maximum throughput occurs. Since the user equipment (UE) moves over time, during a specific time interval (e.g., Busy hour or a time interval in which a specific event occurs), network access demands exceeding maximum capacity increase in at least one base station, but only a very small portion of the maximum capacity may be used at remaining base stations.

Therefore, in the following specification, an embodiment for installing DU resources of an appropriate capacity instead of deploying DU resources of the maximum capacity at each base station site may be described. When DU resources of an appropriate capacity are installed, a cost of RAN deployment may be reduced.

For example, when the DU capacity becomes insufficient as the number of UEs connected to a base station in which a DU of an appropriate capacity is installed increases, a cell for the base station may be moved to a large-capacity cell of DU prepared in the C-RAN Hub. The large number of connected UEs may be processed in the large-capacity cell of DU prepared in the C-RAN Hub. After the cell is moved, remaining resources in the DU of the base station may be used to process remaining cells of the DU. The cell moved to the C-RAN Hub may return to the DU of the original base station when the number of connected UEs is reduced. The DU resources secured in the C-RAN Hub may be used when needed by another base station.

According to an embodiment, according to a virtualized RAN (vRAN), DU resources deployed in a base station site and the C-RAN Hub may be dynamically utilized according to the number of UEs and throughput requirements. For example, by virtualizing a DU function in software, generation, termination, expansion, and reduction of the DU, which is a logical SW entity, may be freely performed regardless of hardware or location. Accordingly, since the DU function may be easily moved between the base station site and the C-RAN Hub, computing resources may be reduced. According to an embodiment, the DU function may also be moved through an Ethernet-based interface technology between the DU and the RU according to an open-RAN (O-RAN).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

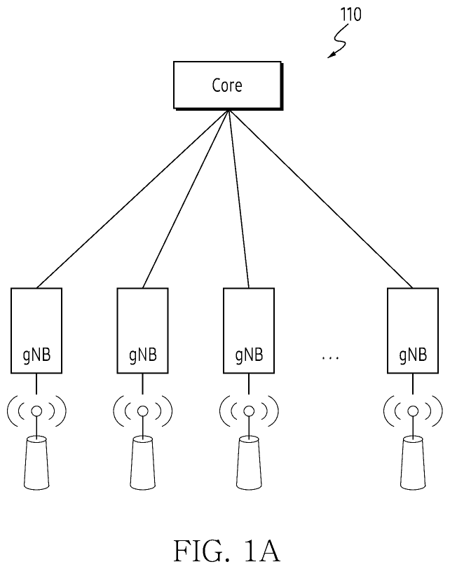

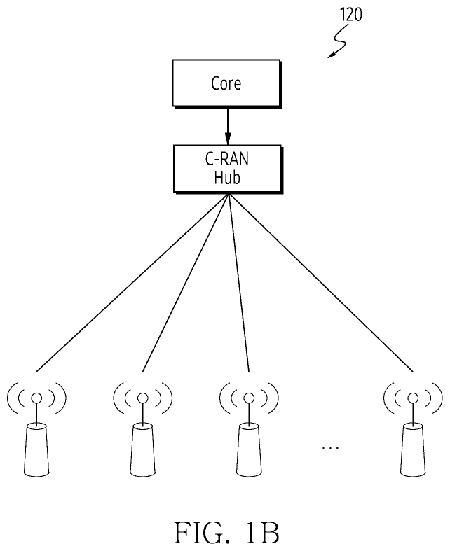

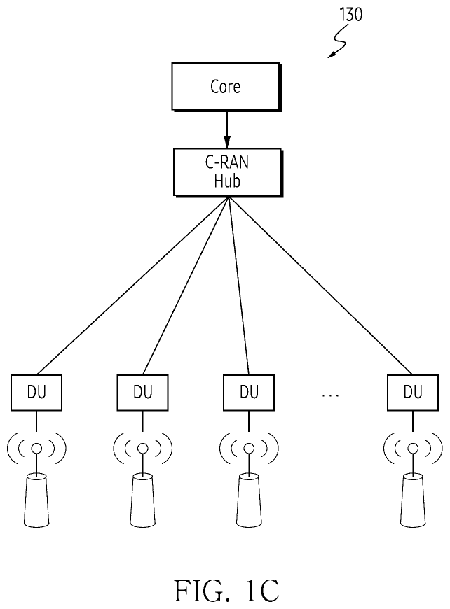

FIGS. 1A, 1B, and 1C illustrate an example of D-RAN, C-RAN, H-RAN structures according to various embodiments of the disclosure.

Referring to FIGS. 1A to 1C, a structure 110 of FIG. 1A indicates a D-RAN structure. A structure 120 of FIG. 1B indicates a C-RAN structure. A structure 130 of FIG. 1C indicates a hybrid-RAN (H-RAN) structure.

In most commercial networks, the RAN deployment structure is configured as either the D-RAN structure or the C-RAN structure. For example, in the D-RAN structure, DUs may be distributed and installed in at each base station. For example, in the C-RAN structure, DUs may be installed in a collected state at a hub site. In the C-RAN structure, a base station may only include RUs and antennas. According to an embodiment, even when virtualization is applied, a vRAN may be established based on the D-RAN structure or the C-RAN structure.

According to FIG. 1A, in the D-RAN structure, a DU of maximum capacity may be installed to support the maximum capacity of each cell in preparation for a time when traffic or UEs are concentrated. However, due to the mobility of UEs, UEs may be concentrated only in some base stations during some time periods. In base stations other than some base stations, only a part of prepared resources may be used.

According to FIG. 1B, a problem similar to the D-RAN structure may occur in the C-RAN structure. In the C-RAN structure, a plurality of base stations may be connected through one DU. In this case, although there is an economic advantage in using hardware or rack space of the DU, a maximum capacity cell resource may be inputted to support each cell.

In the C-RAN structure, compared to the D-RAN structure, only RU and antenna may be disposed at a base station site. Therefore, there is an advantage of reducing the cost of inputting for the base station, but a central office for DU hoteling should be established. In addition, a bandwidth for a fronthaul network between the central office and each base station site should be increased.

According to FIG. 1C, an H-RAN structure such as the structure 130 may be proposed to compensate for the shortcomings of the D-RAN structure and the C-RAN structure. According to the H-RAN structure, the overall RAN construction cost may be reduced by utilizing a virtualization characteristic of the RAN. For example, according to the H-RAN structure, DU HW processing a baseband processing function may be disposed in both the base station and the C-RAN Hub. For example, according to the H-RAN structure, a function for processing the UE or traffic may be dynamically allocated to the DU of the base station or the DU of the C-RAN Hub according to the increase or decrease in the number of UEs and traffic (or mobile traffic).

For example, in the H-RAN structure, as DUs of appropriate capacity rather than maximum capacity are deployed at a base station, the cost for establishing a base station may be reduced. If UEs are concentrated at a base station of appropriate capacity, the processing capacity of the installed DU may be insufficient. When the processing capacity of the DU is insufficient, some of the cells managed by the DU may be processed by the DU of the C-RAN Hub. Afterwards, when the number of UEs accessing the cell where the UEs were concentrated is reduced, the DU for performing the cell processing function may be changed from the DU of the C-RAN Hub to the DU of the base station. Based on the DU for performing the cell processing function being changed from the DU of the C-RAN Hub to the DU of the base station, the DU resources of the C-RAN Hub may be utilized by other base stations.

According to an embodiment, in the H-RAN structure, since there is no need to establish a large-scale C-RAN Hub, the C-RAN Hub may be operated in a state disposed in a shelter in a form of a micro data center without the establishment of the central office.

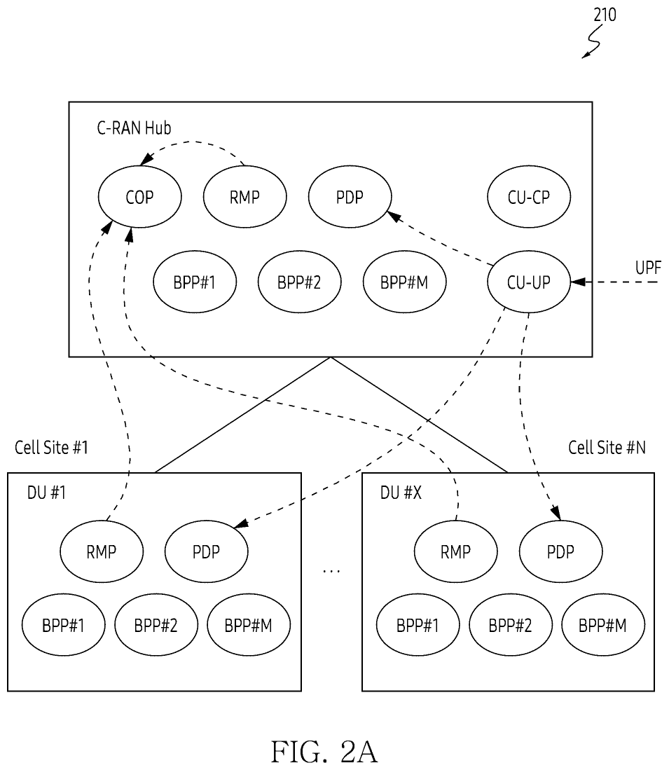

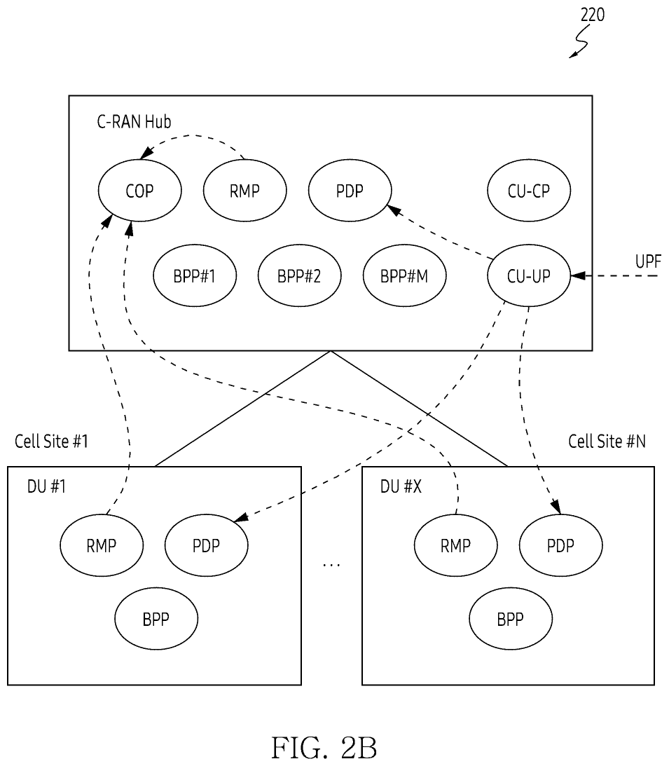

According to an embodiment, in the H-RAN structure, a transport network between the DU and the C-RAN Hub may function as a midhaul and a fronthaul. Sufficient bandwidth may have to be secured in preparation for a time when as many cells (or baseband processing functions) as possible are moved to the C-RAN Hub. In FIGS. 2A and 2B, an example of a specific H-RAN structure may be described.

At least a portion of the network entities described in FIGS. 1A to 1C may be virtualized. For example, at least a portion of the network entities may be virtualized on a cloud platform (e.g., open chassis and blade-specification edge cloud) and configured on a device (e.g., server). The virtualization may support a service in dense urban areas due to sufficiently low latency to meet latency requirements and the rich fronthaul capacity that allows for pooling of baseband unit (BBU) functions to a central location. Since there is no need to attempt near-real-time centralization beyond the limit, the cloud platform may be optimized for the RAN deployment scenario of the disclosure.

FIGS. 2A and 2B illustrate an example of H-RAN structure according to various embodiments of the disclosure.

Referring to FIGS. 2A and 2B, in the H-RAN structure, the baseband processing function may be moved to operate between the base station and the C-RAN hub. A structure 210 and a structure 220 illustrated in FIG. 2A illustrate an example of H-RAN structure implemented based on vRAN (or vRAN software structure).

For example, a baseband processing pod (BBP) may be a module (or unit, software module) for processing a MAC function and a PHY function defined in a standard (e.g., 3GPP standard). In order to free movement of the BPP, an interface between the BPP and the RU may be configured as an interface applied with an O-RAN interface or a separately defined interface based on Ethernet. For example, one BPP may support one or more cells. For example, in the structure 210 of FIG. 2A, one BPP may support one cell. For example, in the structure 220 of FIG. 2B, one BPP may support a plurality of cells.

For example, a packet distributing pod (PDP) may be a module (or unit, software module) for supporting a RLC function defined in a standard (e.g., 3GPP standard) and performing an interface function with a centralized unit-user plane (CU-UP). For example, one DU may include one PDP. The PDP may transmit (or transfer) a packet received from the CU-UP to the BPP to which a destination UE is connected. The PDP may transmit (or transfer) an uplink (UL) packet received from the BPP to the CU-UP.

For example, a RAN managing pod (RMP) may be a module (or unit, software module) for performing an operation administration maintenance (OAM) function managing RAN-related modules in the DU. The RMP may perform an interface function with various modules related to an element management system (EMS), a cell orchestrating pod (COP), and/or management.

For example, a cell orchestrating pod (COP) may determine whether to perform the BPP function at the cell site or at the C-RAN Hub. The COP may periodically collect load information of all managed cells through the RMP. The COP may store and manage the collected information over time. The COP may generate and use history information for each cell. The COP may monitor a current load status and/or a change in the load status. By monitoring the load status and/or the change in the load status, the COP may determine when to move the BPP function of the cell. In order to move the BPP function of the cell, the COP may also monitor computing resource information of the base station site and the C-RAN Hub.

Referring to FIGS. 2A and 2B, a user packet may be transmitted to the PDP through a user plane function (UPF) and a CU-UP. The PDP may transmit (or transfer) a user packet to a destination BPP. The load information of cells managed by the BPP may be transmitted to the COP through the RMP. The COP may obtain the load information of cells managed by the BPP.

In the following specification, the above-described structure 210 and structure 220 may be referred to as a virtualized RAN. For example, the virtualized RAN may be referred to as an elastic vRAN. An example of an operation for performing cell migration according to the structure 210 and structure 220 may be described below.

According to an embodiment, in the C-plane, a terminal and a core network entity (e.g., an access and mobility management entity (AMF)) may perform non-access stratum (NAS) signaling. In the C-plane, a terminal and a base station may perform communication according to a protocol specified in each of a radio resource control (RRC) layer, a packet data convergence protocol (PDCP) layer, a radio link control (RLC) layer, a medium access control (MAC) layer, and a physical (PHY) layer.

The main functions of the RRC layer may include at least a portion of the following functions.
Broadcasting of system information related to access stratum (AS) and NAS
Paging initiated by a 5G core (5GC) or a next generation-radio access network (NG-RAN)
Establishment, maintenance, and release of RRC connection between the UE and the NG-RAN, including the following (a and b):
a. Addition, modification, and release of carrier aggregation
b. Addition, modification, and release of dual connectivity between new radio (NR) and either evolved universal terrestrial radio access (E-UTRA) or NR
Security functions including key management
Establishment, configuration, maintenance, and release of Signaling Radio Bearer (SRB) and Data Radio Bearer (DRB)
Movement functions including the following (a to c):
a. Handover and context transfer
b. UE cell selection and reselection, and control of cell selection and reselection
c. Mobility across radio access technologies (RATs)
Quality of service (QoS) management function
UE measurement reporting and control of the reporting
Detection and recovery of radio link failure
Transmission of messages from/to the NAS to/from the UE

The main functions of the PDCP layer may include at least a portion of the following functions.
Header compression and decompression (robust header compression (ROHC) only)
Transfer of user data
In-sequence delivery of upper layer protocol data units (PDUs)
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink

The main functions of the RLC layer may include at least a portion of the following functions.
Transfer of upper layer PDUs
In-sequence delivery of upper layer PDUs
Out-of-sequence delivery of upper layer PDUs
Error Correction through automatic repeat request (ARQ)
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The MAC layer may be connected to a plurality of RLC layer devices configured in one terminal, and the main functions of the MAC may include at least a portion of the following functions.
Mapping between logical channels and transport channels
Multiplexing/demultiplexing of MAC SDUs
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

The physical layer may include operations of channel-coding and modulating upper layer data to generate orthogonal frequency division multiplexing (OFDM) symbols and transmit them over a wireless channel, or operations of demodulating OFDM symbols received through the wireless channel and performing channel decoding to transfer them to an upper layer.

According to an embodiment, in the U-plane, a terminal and a base station may perform communication according to a protocol specified in each of a service data adaptation protocol (SDAP) layer, the PDCP layer, the RLC layer, the MAC layer, and the PHY layer.

The SDAP layer may provide a QoS flow of 5GC. A single protocol entity of SDAP may be configured for each individual PDU session, and functions of the SDAP layer may include at least a portion of the following functions.
Mapping between QoS flows and data radio bearer
Indicate QoS flow identifier (ID) (QFI) in both downlink (DL) and UL packets

As communication technology develops, mobile data traffic increases, and accordingly, the bandwidth demand required in a fronthaul between a digital unit and a wireless unit has increased significantly. In a deployment such as a centralized/cloud radio access network (C-RAN), the DU may be implemented to perform functions for a packet data convergence protocol (PDCP), radio link control (RLC), media access control (MAC), and physical (PHY), and the RU may be implemented to further perform functions for the PHY layer in addition to a radio frequency (RF) function.

The DU may be responsible for upper layer functions of the wireless network. For example, the DU may perform functions of the MAC layer and a portion of the PHY layer. Herein, a portion of the PHY layer refers to functions performed at a higher level among the functions of the PHY layer, and may include, for example, channel encoding (or channel decoding), scrambling (or descrambling), modulation (or demodulation), and layer mapping (or layer demapping). According to an embodiment, the DU may be alternatively represented as a first network entity for a base station (e.g., gNB) in embodiments of the disclosure as needed.

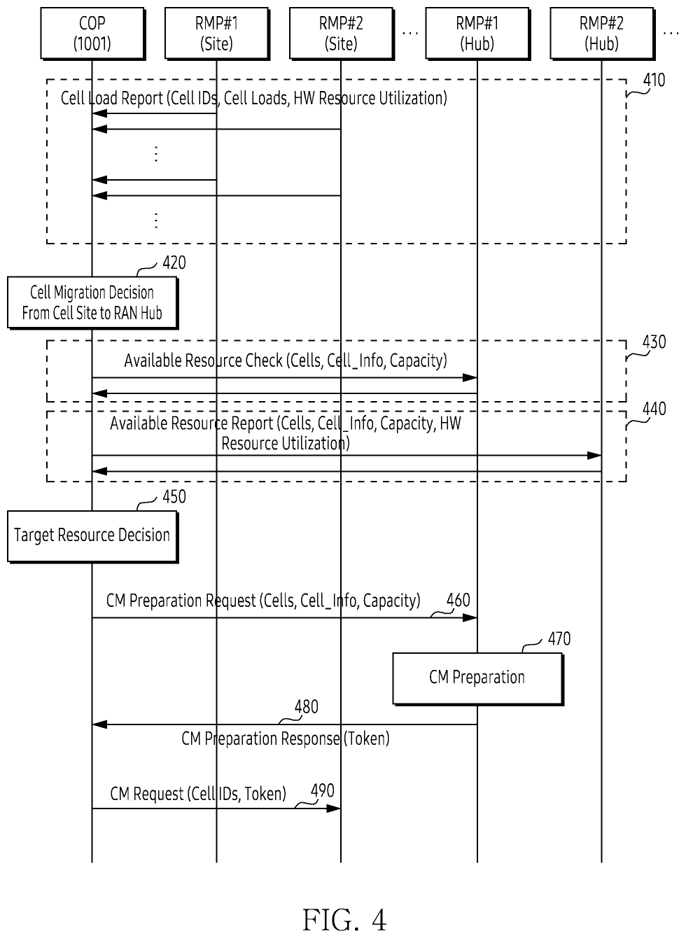

The RU may be responsible for lower layer functions of the wireless network. For example, the RU may perform a portion of the PHY layer, and an RF function. Herein, a portion of the PHY layer refers to functions of the PHY layer performed at a relatively lower level than the DU, and may include, for example, inverse fast Fourier transform (iFFT) conversion (or FFT conversion), CP insertion (CP removal), and digital beamforming. An example of such specific function split is described in detail in FIG. 4. The RU may be referred to as ‘access unit (AU)’, ‘access point (AP)’, ‘transmission/reception point (TRP)’, ‘remote radio head (RRH)’, ‘radio unit (RU)’ or another term having equivalent technical meanings. According to an embodiment, the RU may be alternatively represented as a second network entity for a base station (e.g., gNB) in embodiments of the disclosure as needed.

According to an embodiment, the base station may include DU and RU. However, it is not limited thereto. The base station according to the embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include a digital unit (DU) and a radio unit (RU). Between a core (e.g., 5G core (5GC) or next generation core (NGC)) network and a radio network (RAN), the base station may be implemented in a structure in which CU, DU, and RU are disposed in that order. An interface between the CU and the distributed unit (DU) may be referred to as an F1 interface.

A centralized unit (CU) may be connected to one or more DUs and may be in charge of functions of a higher layer than the DU. For example, the CU may be in charge of functions of radio resource control (RRC) and packet data convergence protocol (PDCP) layers, and the DU and RU may be in charge of functions of lower layers. The DU may perform some functions (high PHY) of radio link control (RLC), media access control (MAC), and physical (PHY) layers, and the RU may be in charge of remaining functions (low PHY) of the PHY layer. In addition, as an example, a digital unit (DU) may be included in a distributed unit (DU), according to the implementation of distributed deployment of the base station. The following is described as operations of a digital unit (DU) and RU unless otherwise defined, but various embodiments of the disclosure may be applied to both a base station deployment including CU or a deployment in which DU is directly connected to a core network (i.e., CU and DU are integrated to a base station that is a single entity (e.g., NG-RAN node)).

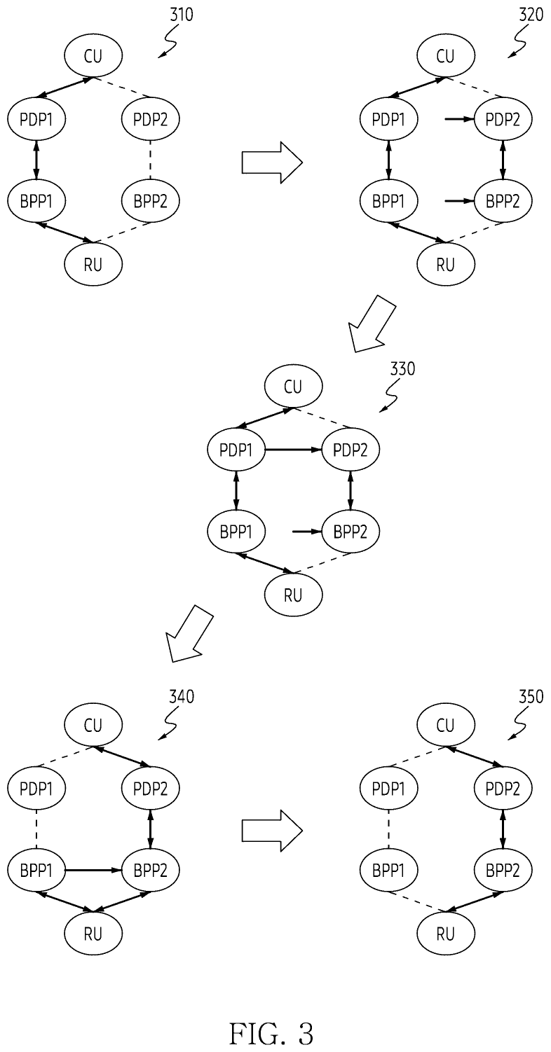

FIG. 3 illustrates an example of cell migration operation in a virtualized RAN according to an embodiment of the disclosure.

Referring to FIG. 3, the cell migration operation of the virtualized RAN may be composed of the following four operations (4 steps).
1) Cell load information collection and cell migration (CM) determination operation
2) Cell migration (CM) preparation operation
3) PDP relocation operation
4) BPP relocation operation

According to an embodiment, when a cell migration operation of a virtualized RAN is performed, the COP may be deployed in the C-RAN Hub, and the RMP may be deployed in each DU of the C-RAN Hub and the cell site. Hereinafter, the cell migration operation in a case where the COP is deployed in the C-RAN Hub, and the RMP is deployed in each DU of the C-RAN Hub and the cell site is described, but is not limited thereto.

For example, the RMP may manage RAN function support software entity (or network element) such as BPP and PDP operating in the DU. The BPP may handle one or more cells. The PDP may receive user data from CU and distribute user data to one or more BPPs.

For example, moving a cell from a DU of the cell site to a DU of the C-RAN Hub and/or moving a cell from a DU of the C-RAN Hub to a DU of the cell site may mean changing a data path between the CU and the RU, as illustrated in FIG. 3. Moving a cell from a DU of the cell site to a DU of the C-RAN Hub and/or moving a cell from a DU of the C-RAN Hub to a DU of the cell site may mean relocating PDP and BPP, and the like.

State 310 may indicate a state before CM starts. In state 310, a service may be provided to a cell regarding the RU through PDP1 and BPP1 between the CU and the RU. In state 350 indicating a state after CM is completed, a service may be provided to a cell regarding the RU through PDP2 and BPP2 between the CU and the RU. In order to change the PDP and BPP and change the path between the CU and the RU, the above-described cell migration (CM) preparation operation, PDP relocation operation, and BPP relocation operation may be performed.

State 320 may indicate a state in which the cell migration (CM) preparation operation is performed. In state 320, PDP2 and BPP2 may be generated, or an existing network element (NE) may be used. PDP2 and BPP2 may activate an address and port so that PDP1 and BPP1 may connect for CM.

State 330 may indicate a state in which the PDP relocation operation is performed. In state 330, PDP1 may transfer context information to PDP2 for bearers related to a cell to be transferred. After transferring context information to PDP2, PDP1 may stop the RLC function. PDP1 may transmit (or transfer) a packet received from CU or BPP to PDP2.

The state 340 may indicate a state in which the BPP relocation operation is performed. In the BPP relocation step, BPP1 may transfer context information for bearers related to the cell to be transferred to BPP2, and then stop the scheduling function. BPP1 may transmit (or transfer) data received from the RU to BPP2.

State 350 may indicate a state in which CM is completed. When the RU starts transmitting UL data to BPP2, cell migration is completed, and after cell migration is completed, BPP1 may no longer process the corresponding cell.

Hereinafter, in the specification, an operation between the C-RAN hub and a plurality of DUs connected to the C-RAN hub for cell load information collection and cell migration (CM) determination operation for CM operation of a virtualized RAN, CM preparation operation, PDP relocation operation, and BPP relocation operations may be described.

FIG. 4 illustrates an example of a cell load information collection and a cell migration (CM) determination operation and a CM preparation operation, according to an embodiment of the disclosure.

Referring to FIG. 4, in operations 410 and 420, COP may collect cell load information and perform a CM determination operation.

According to an embodiment, COP 1001 may periodically collect (or obtain) load information (e.g., traffic volume or number of users) of each cell and resource utilization information (e.g., central processing unit (CPU) utilization information and memory utilization information) of hardware from a plurality of RMPs, or collect (or obtain) them when a specified event occurs. As the load increases, if the increased load is expected to exceed the capacity of the baseband processing pod (BPP) processing a corresponding cell, the COP 1001 may determine to move the cell or a plurality of cells including the cell to a C-RAN Hub with sufficient hardware resources. The operation of the COP 1001 for the above-described embodiment may be described below. For example, each of RMP #1 (site) and RMP #2 (site) may be included in DUs distinct from the C-RAN Hub. RMP #1 (Hub) and RMP #2 (Hub) may be included in the C-RAN Hub.

1) In operation 410, the COP 1001 may receive a cell load report message from each of the plurality of RMPs. For example, the COP 1001 may periodically collect (or obtain) various information including cell load information and HW resource utilization information from the plurality of RMPs. For example, the RMP (e.g., RMP #1(site), RMP #2(site), RMP #1(Hub), and RMP #2(Hub)) may collect cell load information from one BPP or a plurality of BPPs operating in the same DU. The RMP may report (or transmit) the cell load information together with the HW resource utilization information to the COP 1001.

For example, the cell load information may include information about throughput, information about traffic volume, information about the number of users, and/or information about the number of bearers. For example, the HW resource utilization information may include CPU utilization information, memory utilization information, and/or buffer usage information. The above-described cell load information may be transmitted to the COP 1001 together with the Cell ID, Cell Capacity, BPP ID, and the like.

2) In operation 420, the COP 1001 may determine a cell to be moved to the C-RAN Hub, based on information collected from RMP (e.g., RMP #1 (site) and RMP #2 (site)) of each cell site. For example, the COP 1001 may determine a cell of RMP #2 (site) as a cell to be moved to the C-RAN Hub.

For example, when the number of UEs or the number of bearers increases beyond a specified number based on the maximum capacity of the cell provided by BPP, or throughput exceeds a specified threshold range based on maximum performance, the cell may be determined as a cell to be moved to the C-RAN Hub.

3) In operation 430, the COP 1001 may transmit an available resource check message to RMPs included in each DU of the C-RAN Hub. The COP 1001 may check whether the cell to be moved is acceptable in RMPs (e.g., RMP #1 (Hub) and RMP #2 (Hub)) included in each DU of the C-RAN Hub. For example, the COP 1001 may transmit information about a cell to be moved to the RMPs included in each DU. Information about a cell to be moved may include information for determining whether a cell to be moved is supported in the RMP. For example, information about a cell to be moved may include information about a frequency band, information about an air bandwidth, information about air tech (e.g., 4G or 5G), information about subcarrier spacing, and/or information about standard (e.g., 3GPP standard version). For example, the capacity may be set to be larger than the capacity supported by the cell site.

4) In operation 440, the RMPs (e.g., RMP #1(Hub) and RMP #2(Hub)) included in each DU of the C-RAN Hub may transmit an available resource check message to the COP 1001. Each RMP may provide (or transmit) the acceptability of a cell to be moved and current resource utilization information of the corresponding DU to the COP 1001.

According to an embodiment, if the COP 1001 is already interworking with each RMP and managing the capacity of the large-capacity cell, operation 430 (or procedure 3) and operation 440 (or procedure 4) may be omitted. The COP 1001 may perform operation 450 (or operation 460) without performing operation 430 and operation 440.

5) In operation 450, the COP 1001 may determine one of candidate RMPs capable of accommodating a cell to be moved, based on a specified criterion. For example, the COP 1001 may select an RMP with small HW resource utilization among the candidate RMPs. For example, the COP 1001 may select an RMP that is closest to the cell site among the candidate RMPs. For example, the COP 1001 may select RMP #1 (Hub).

6) In operation 460, the COP 1001 may transmit a CM preparation request message to a selected RMP (e.g., RMP #1 (Hub)). The COP 1001 may request the selected RMP (e.g., RMP #1 (Hub)) to prepare the CM. For example, the COP 1001 may transmit the cell ID, capacity, and/or cell information to the selected RMP together with the CM preparation request.

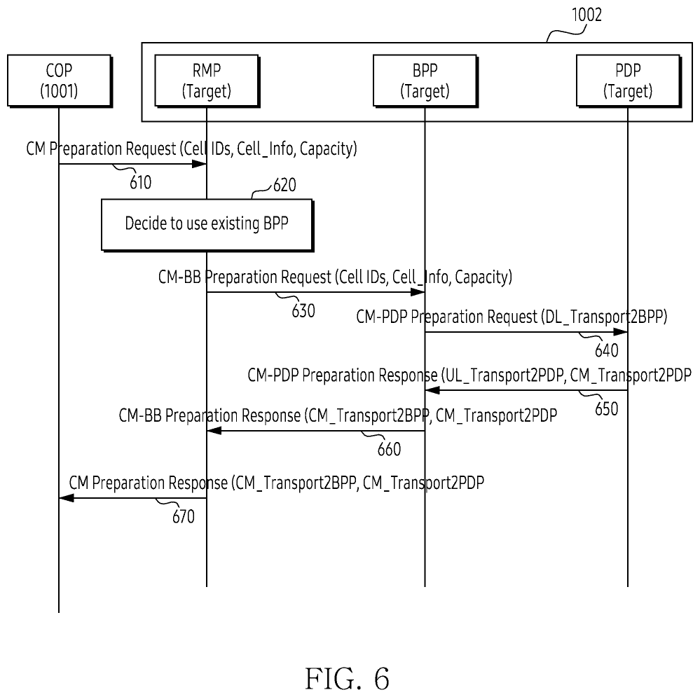

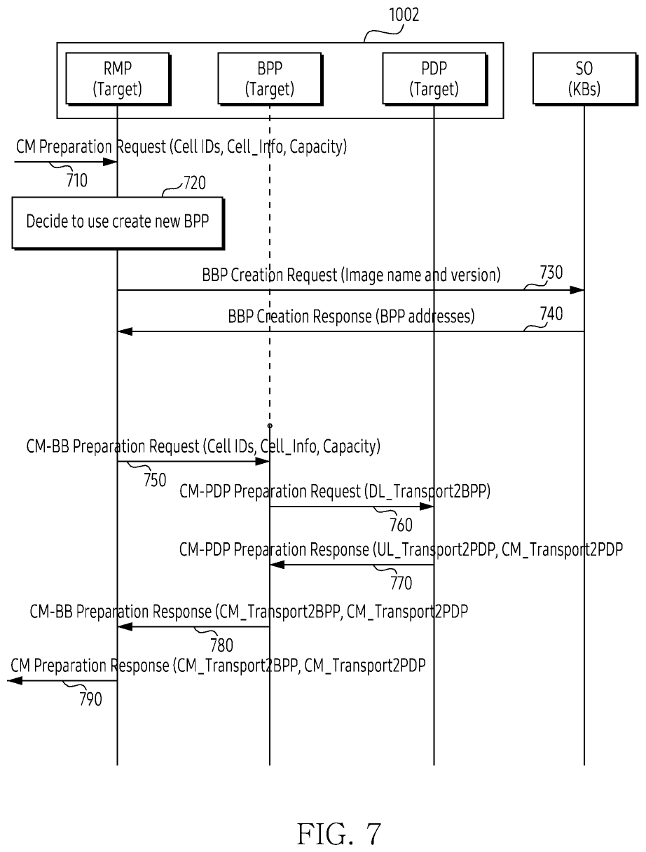

7) In operation 470, the selected RMP (e.g., RMP #1 (Hub)) may perform preparation for CM by interworking with entities (SW entities) including BPP and PDP included in the DU related to a cell to be moved. Specific operations for the selected RMP to perform preparation for CM will be described later with reference to FIGS. 6 and 7.

8) In operation 480, the COP 1001 may receive a CM ready response message from the selected RMP (e.g., RMP #1 (Hub)). When the CM preparation is completed, the selected RMP may transmit (or transfer) a token (or information) containing address information such as BPP and PDP for the CM to the COP 1001.

9) In operation 490, the COP 1001 may transmit a CM request message to RMP (e.g., RMP #2 (Site)) related to a cell to be moved. The COP 1001 may provide (or transmit) the token received in operation 480 (or procedure 8) to the source RMP for migration of the cells determined in operation 420 (or procedure 2). The COP 1001 may provide the token to the source RMP and request initiation of CM.

10) After operations 410 to 490 are performed, CM may be performed. Specific operations for CM will be described later.

According to an embodiment, after some cells are moved from the cell site to the C-RAN Hub, remaining cells in the cell site may use more HW resources. In order for the remaining cells in the cell site to use more HW resources, the RMP may allocate more CPU resources and/or memory resources to the BPP in the corresponding DU by interworking with a service orchestrator (SO), or enhance the processing capacity of the BPP through container replication. In addition, the RMP may further expand the limited capacity by modifying configuration (or configuration information) of the BPP, if necessary.

SO is responsible for RAN domain management and an orchestration function. The main functions of SO providing RAN support include fault, configuration, alarms, performance and security (FCAPS) interface with respect to network function (NF), non-real time RAN intelligent controller (Non-RT RIC) framework for RAN optimization, O-Cloud management, orchestration, and workflow management functions.

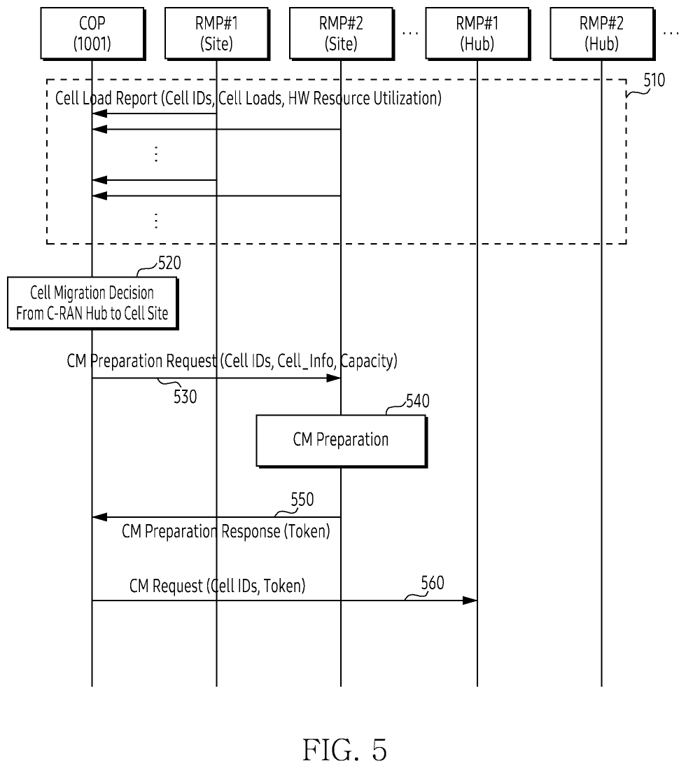

FIG. 5 illustrates an example of an operation for a CM when a load of a cell is reduced, according to an embodiment of the disclosure.

Referring to FIG. 5, operations 510 to 560 may indicate operations for returning management of a cell to the cell site when the load of the cell being operated by the COP 1001 in the C-RAN Hub is reduced.

1) In operation 510, the COP 1001 may receive cell load report messages from a plurality of RMPs, respectively. The COP 1001 may periodically collect (or obtain) cell load information and HW resource utilization information from RMPs (e.g., RMP #1 (Hub) and RMP #2 (Hub)) of C-RAN Hub. The RMP may collect cell load information from one BPP or a plurality of BPPs operating in the same DU. The RMP may report (or transmit) cell load information together with HW resource utilization information to the COP 1001. For example, operation 510 may correspond to operation 410 of FIG. 4.

For example, the cell load information may include information about throughput, information about traffic volume, information about the number of users, and/or information about the number of bearers. For example, the HW resource utilization information may include CPU utilization information, memory utilization information, and/or buffer usage information. The above-described cell load information may be transmitted to the COP 1001 together with the Cell ID, the capacity of the cell, and/or the BPP ID.

2) In operation 520, the COP 1001 may determine a cell to be returned to the cell site, based on information collected from the RMP. For example, when the number of UEs or the number of bearers of the cell decreases below a specified number or the throughput decreases below a specified threshold range, the cell may be determined to be returned to the cell site. As an example, the COP 1001 may determine to move the cell back to the cell site.

3) In operation 530, the COP 1001 may transmit a CM preparation request message to RMP (e.g., RMP #2 (Site)) of the existing DU. The COP 1001 may request the RMP of the DU to prepare cell migration (CM), in order to return (or move) the cell determined in operation 520 (or step 2) to the DU of the existing Cell Site. At this time, the capacity of the cell may be set to a designated capacity (or an appropriate capacity) according to the reduced demand.

4) In operation 540, the RMP may perform preparation for CM by interworking with entities (SW entities) including BPP and PDP within the DU. Specific operations for the RMP to perform preparation for CM will be described later in FIGS. 6 and 7. For example, operation 540 may correspond to operation 470 of FIG. 4.

5) In operation 550, when the CM preparation is completed, the RMP may transmit (or transfer) a token (or information) including address information of BPP and PDP for the CM to the COP 1001. For example, operation 550 may correspond to operation 480 of FIG. 4.

6) In operation 560, the COP 1001 may provide (or transmit) the token received in operation 550 (or procedure 5) to RMP (e.g. RMP #1 (Hub)) of C-RAN Hub for migration to cells determined in operation 520 (or procedure 2). The COP 1001 may provide the token to RMP of C-RAN Hub and request initiation of CM. For example, operation 560 may correspond to operation 490 of FIG. 5.

7) After operations 510 to 560 are performed, CM may be performed. Specific operations for CM will be described later.

In the following specification, an existing DU related to a cell to be moved may be referred to as a source DU. A DU for performing a process related to a cell to be moved according to CM may be referred to as a target DU. For example, RMP, BPP, and PDP of the source DU may be referred to as a source RMP, a source BPP, and a source PDP, respectively. For example, RMP, BPP, and PDP of the target DU may be referred to as a target RMP, a target BPP, and a target PDP, respectively.

FIG. 6 illustrates an example of a CM preparation operation according to an embodiment of the disclosure.

Referring to FIG. 6, operations 610 to 670 may indicate operations for CM preparation when a BPP is operating in a target DU 1002. For example, when one BPP may process a plurality of cells, it may accommodate a new cell in addition to the cell previously being processed. For example, RMP, BPP, and PDP included in the target DU may be referred to as a target RMP, a target BPP, and a target PDP, respectively. For example, the target DU and the COP 1001 may be included in the C-RAN Hub. Although not illustrated, the BPP and PDP used in the source DU before the CM is performed may be referred to as the source BPP and the source PDP, respectively.

1) In operation 610, the COP 1001 may transmit a CM preparation request message to the target RMP. The COP 1001 may request the RMP to prepare CM.

2) In operation 620, the COP 1001 may determine a target BPP capable of additionally processing a requested cell among the BPPs managed by the target RMP. The BPP may have restrictions set according to a radio band, a type of technology (e.g., 4G or 5G), and/or features of the BPP. Accordingly, the COP 1001 may select a BPP based on cell information and information on the capacity of the cell.

3) In operation 630, the target RMP may transmit a CM-baseband (BB) preparation request message to the target BPP. The target RMP may request CM preparation to the target BPP. For example, the COP 1001 may transmit cell ID, capacity, and/or cell information to the BPP together with the CM preparation request.

4) In operation 640, the target BPP may transmit a CM-PDP preparation request message to the target PDP. The target BPP may request the target PDP to prepare CM. For example, the target BPP may transmit (or provide) its transport address to the target PDP so that a bearer connection may be established with the target PDP.

5) In operation 650, the target PDP may transmit a CM-PDP preparation response message to the target BPP. The target PDP may transmit (or provide) its address information to the target BPP so that it may receive RLC and bearer context information from the source PDP.

6) In operation 660, the target BPP may transmit a CM-baseband (BB) preparation response message to the target RMP. The target BPP may transmit (or provide) its address and the address of the target PDP to the target RMP as a single token so that it may perform CM.

7) In operation 670, the target RMP may transmit a CM preparation response message to the COP 1001. The target RMP may transmit information indicating that CM preparation is complete to the COP 1001. For example, the target RMP may transmit (or provide) the transport layer addresses of the target BPP and the target PDP to the COP 1001 in the form of a token so that the source BPP and the source PDP may directly connect to the target BPP and the target PDP.

FIG. 7 illustrates an example of a CM preparation operation according to an embodiment of the disclosure.

Referring to FIG. 7, operations 710 to 790 may indicate operations for CM preparation when there is no BPP in the target DU 1002. For example, the target RMP of the target DU 1002 may create a target BPP in conjunction with a service orchestrator (SO). The target RMP may prepare CM based on the created target BPP. For example, RMP, BPP, and PDP included in the target DU 1002 may be referred to as a target RMP, a target BPP, and a target PDP, respectively. Although not illustrated, the BPP and PDP used before the CM is performed may be referred to as a source BPP and a source PDP, respectively.

1) In operation 710, the COP 1001 may transmit a CM preparation request message to the target RMP. The COP 1001 may request CM preparation to the target RMP. For example, the COP 1001 may transmit cell ID, capacity, and/or cell information to the target RMP together with the CM preparation request.

2) In operation 720, when the target DU 1002 does not have a BPP or when there is a BPP but it cannot additionally accommodate the required CM, the target RMP may determine to create a new BPP. For example, the PDP may already be in operation. According to an embodiment, when the target DU 1002 also does not have a PDP, the target RMP may determine to create a new PDP, similar to creating a new BPP.

3) In operation 730, the target RMP may transmit a BPP creation request message to a service orchestrator (SO). The target RMP may request the SO to create a BPP. The SO may be a controller or a virtual network function (VNF) management (VNFM) for managing a life cycle of VNF.

4) In operation 740, the SO may transmit a BPP creation response message to the target RMP. After creating the BPP, the SO may provide the ID or address of the BPP to the target RMP.

5) In operation 750, the target RMP may transmit a CM-BB preparation request message to the created target BPP. The target RMP may transmit (or provide) ID, cell information, and/or capacity information of a cell to be moved to the target BPP, and request the target BPP to prepare the CM.

6) In operation 760, the target BBP may transmit a CM preparation request message to the target PDP. The target BBP may request the target PDP to prepare the CM.

7) In operation 770, the target PDP may transmit a CM preparation response message to the target BBP. The target PDP may transmit (or provide) its address information to the target BPP so that it may receive RLC and bearer context information from the source PDP.

8) In operation 780, the target BPP may transmit a CM-BB preparation response message to the target RMP. The target BPP may transmit (or provide) its address and the address of the target PDP to the target RMP as a single token so that it may perform CM.

9) In operation 790, the target RMP may transmit a CM preparation response message to the COP 1001. The target RMP may transmit information indicating that CM preparation is complete to the COP 1001. For example, the target RMP may transmit (or provide) the transport layer addresses of the target BPP and the target PDP to the COP 1001 in the form of a token so that the source BPP and the source PDP may directly connect to the target BPP and the target PDP.

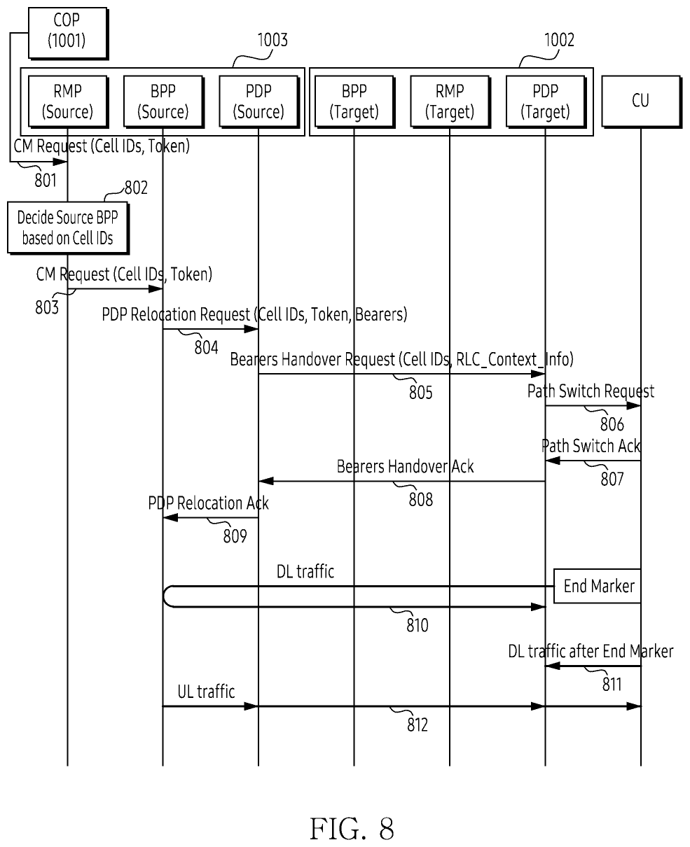

FIG. 8 illustrates an example of a packet distributing pod (PDP) relocation operation according to an embodiment of the disclosure.

Referring to FIG. 8, when the CM preparation operation is completed in the target DU 1002, the COP 1001 may request a CM to a source RMP regarding a source DU 1003. The source RMP may check the source BPP and request a CM to the source BPP. The source BPP may perform a PDP relocation operation. After the PDP relocation operation is performed, the source BPP may perform a BPP relocation operation. Operations 801 to 812 may indicate the PDP relocation operation.

1) In operation 801, the COP 1001 may transmit a CM request message to the source RMP of the source DU 1003. The COP 1001 may request a CM to the source RMP of the source DU 1003. For example, the COP 1001 may transmit a token (or information) including address information of the source BPP and source PDP for the CM and a cell ID to the source RMP of the source DU 1003 and request initiation of the CM.

2) In operation 802, the source RMP may determine (or select) the source BPP, based on cell ID information of a cell to be moved.

3) In operation 803, the source RMP may transmit a CM request message to the source BPP. The source RMP may request a CM to the source BPP. For example, the source RMP may transmit (or provide) the transport layer address of the target BPP and the target PDP to the source BPP in the form of a token.

4) In operation 804, the source BPP may transmit a PDP relocation request message to the source PDP. The source BPP may request relocation to the source PDP before starting a cell migration procedure of the source BPP. The source BPP may transmit (or transfer) information about bearers belonging to a cell to be moved to the source PDP when requesting relocation to the source PDP. According to an embodiment, when the source PDP may identify bearers belonging to the cell only with cell ID information, the source BPP may not transmit information about bearers belonging to a cell to be moved.

The source BPP may stop a down link (DL) scheduling operation before requesting the source PDP to relocate. For example, the source BPP may no longer request a DL packet from the source PDP. In this case, the source BPP may continue to process UL packets, process UL packets received from the RU, and then transmit (or transfer) them to the source PDP.

5) In operation 805, the source PDP may transmit a bearers handover request message to the target PDP. The source PDP receiving the PDP relocation request message may stop RLC Processing of bearers associated with a cell to be moved. The source PDP may transmit (or transfer) information (e.g., CU and general packet radio service tunnelling protocol (GTP) tunnel information) about bearers associated with a cell to be moved and RLC information associated with a cell to be moved to the target PDP. Operation 805 may be performed to move RLC entities for all UEs connected to a cell to be moved from the source PDP to the target PDP. The source PDP may buffer DL packets and UL packets until it receives a response message from the target PDP.

6) In operation 806, the target PDP may transmit a path switch request message to the CU. For example, the target PDP receiving a bearers handover request message may store the received RLC context information. The target PDP may transmit a path switch request message to the CU (the CU notified by the source PDP) for the corresponding bearers. For example, the target PDP may transmit transport layer information for receiving DL packets from the CU together with the path switch request message.

7) In operation 807, the CU may transmit a path switch ack message to the target PDP. For example, the CU receiving the path switch request message may update the connection information with the PDP for each Bearer that requested path switching from the source PDP to the target PDP. The CU may lastly transmit an “End Marker” indication packet for each Bearer to the existing source PDP. The CU may transmit the DL packet generated after transmitting the “End Marker” indication packet to the target PDP. The CU may transmit a path switch ack message to the target PDP.

8) In operation 808, the target PDP may transmit a bearers handover ack message to the source PDP. The bearers handover ack message may include a transport layer address so that the target PDP may forward packets to the source PDP. The target PDP may buffer DL packets received from the CU.

9) In operation 809, the source PDP may forward DL/UL data to the target PDP in response to receiving a Bearers Handover Ack message from the target PDP. In addition, the source PDP may notify the source BPP that the PDP relocation is complete, by transmitting a PDP relocation ack message to the source BPP.

10) In operation 810, the CU may lastly transmit an “End Maker” indication packet to the source PDP, after transmitting a path switch response message as described in operation 807. The “End Maker” indication packet may be transmitted to the target PDP through the source PDP.

11) In operation 811, as described in operation 807, the CU may directly transmit (or transfer) DL packets that occur after transmitting the “End Maker” indication packet to the source PDP to the target PDP. The target PDP may preferentially process packets received from the source PDP until it receives the “End Maker” indication packet. The target PDP may process DL packets received from the CU after receiving the “End Maker” indication packet.

12) In operation 812, the UL packet processed in the source BPP may be transmitted (or transferred) to the source PDP. For example, the source PDP may transmit (or transfer) the UL packet processed in the BPP to the target PDP without processing the UL packet. Even when the target PDP receives the UL packet, it may preferentially process the packet received from the source PDP until it receives the “End Maker” indication packet.

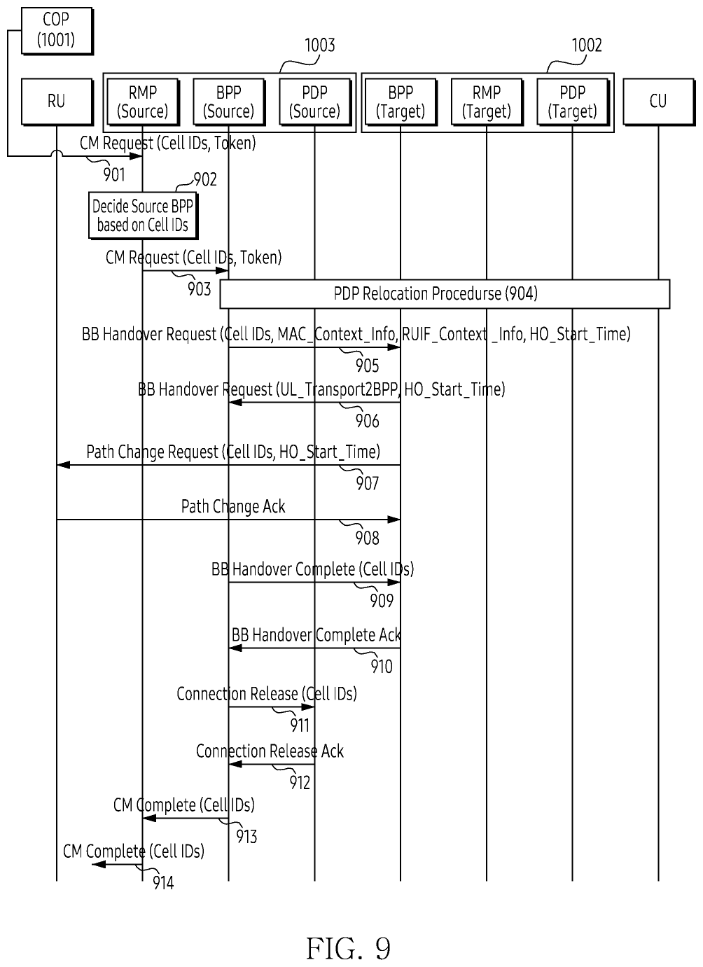

FIG. 9 illustrates an example of a baseband processing pod (BPP) relocation operation according to an embodiment of the disclosure.

Referring to FIG. 9, when the PDP relocation operation is completed, a CM procedure between the source BPP and the target BPP may be performed. Operations 901 to 914 may indicate a BPP relocation operation. The source BPP and the target BPP may set a change time, and switch a device performing the BPP operation from the source BPP to the target BPP based on the change time.

1) In operation 901, the COP 1001 may transmit a CM request message to the source RMP of the source DU 1003. The COP 1001 may request a CM from a source RMP of the source DU 1003. Operation 901 may correspond to operation 801 of FIG. 8.

2) In operation 902, the source RMP may determine (or select) the source BPP based on cell ID information of a cell to be moved. Operation 902 may correspond to operation 802 of FIG. 8.

3) In operation 903, the source RMP may transmit a CM request message to the source BPP. The source RMP may request a CM to the source BPP. Operation 903 may correspond to operation 803 of FIG. 8.

4) In operation 904, a PDP relocation operation may be performed. Operation 904 may correspond to operations 803 to 812 of FIG. 8.

5) In operation 905, the source BPP may transmit a BB handover request message to the target BPP. The source BPP may request a switchover for baseband function to the target BPP. For example, the BB handover request message may include cell ID information, MAC context information, interface information with RU, and/or switchover start time information.

The source PDP may be in a state in which scheduling for DL user packets has already been stopped when the PDP relocation operation started. However, the source PDP may be in a state of continuing to perform an UL scheduling and a cell-related scheduling operation that is not related to user packets. The source PDP may stop scheduling for DL user packets only until the HO_Start_Time, and may perform the cell-related scheduling operation.

6) In operation 906, the target BPP may transmit a BB handover ack message to the source BPP. For example, the target BPP receiving the BB handover request message may establish a MAC scheduling context for UEs of a cell to be moved. The target BPP may setup (or establish) a connection for the target PDP and a bearer associated with a cell to be moved. The target BPP may check whether it may start DL/UL scheduling until HO_Start_Time. According to an embodiment, the target BPP may propose a new HO_Start_Time when it does not have enough time to start DL/UL scheduling until HO_Start_Time.

The target BPP may set configuration (configuration information) to communicate with the RU according to RUIF_Context_Info provided from the source BPP. The target BPP may transmit a BB handover ack message to the source BPP.

The source BPP receiving the BB handover ack message may process packets for UL data received from the RU until HO_Start_Time. The source BPP may optionally process scheduling functions including DL scheduling by considering BPP relocation. The source BPP may transmit (or transfer) information required for scheduling to the target BPP after HO_Start_Time.

The target BPP may pre-transmit DL packets to be transmitted over the air from HO_Start_Time, even before HO_Start Time, when a path change is performed with the RU through operations 907 and 908.

7) In operation 907, the target BPP may transmit a path change request message to the RU, in order to perform Connection setup with the RU. The path change request message may include a cell ID of a cell whose path is to be moved and HO_Start_Time, which is time information for starting the path change. The RU may transmit packets received from the target BPP starting from the HO_Start_Time based on the transmission time when it transmitted over the air. The RU may transmit all UL packets to the target BPP starting from the HO_Start_Time based on an Air reception time.

8) In operation 908, the RU may transmit a path change ack message to the target BPP in response to the path change request message. The path change may be performed (or occurred) based on HO_Start_Time. Packets received from the target BPP before HO_Start_Time may be buffered and then released into the air at a predetermined time after HO_Start_Time has elapsed.

9) In operation 909, the target BPP may transmit a BB handover complete message to the source BPP, based on receiving the path change ack message from the RU.

10) In operation 910, after receiving the BB handover complete message, the source BPP may respond to the target BPP with a BB handover complete ack message.

11) In operation 911, the source BPP may no longer transmit DL packets to the RU. The source BPP may release the allocated resources based on determining that no UL packets will be received from the cell for the RU. The source BPP may transmit a connection release message to the source PDP. The source BPP may release a connection for the cell and the bearer associated with the cell, based on transmitting the connection release message.

12) In operation 912, the source PDP may release all CM-related resources and transmit a Connection Release Ack message to the source BPP.

13) In operation 913, the source BPP may release all CM-related resources and transmit a CM complete message to the source RMP.

14) In operation 914, the source RMP may transmit a CM complete message to the COP 1001. The source RMP may inform the COP 1001 that the CM is completed.

In the above-described embodiments, the operation of a cell moving from the source DU of the cell site to the target DU of the C-RAN Hub is described, but is not limited thereto. The cell may also move from the source DU of the C-RAN Hub to the target DU of the cell site.

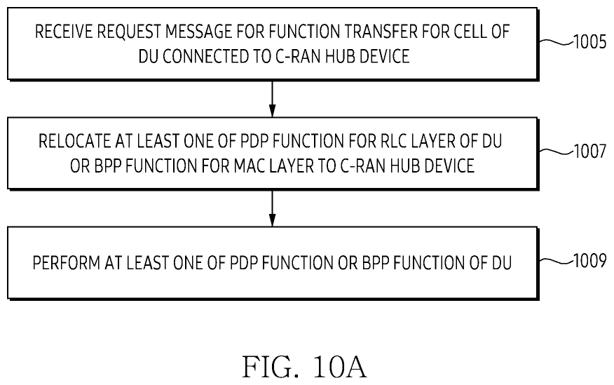

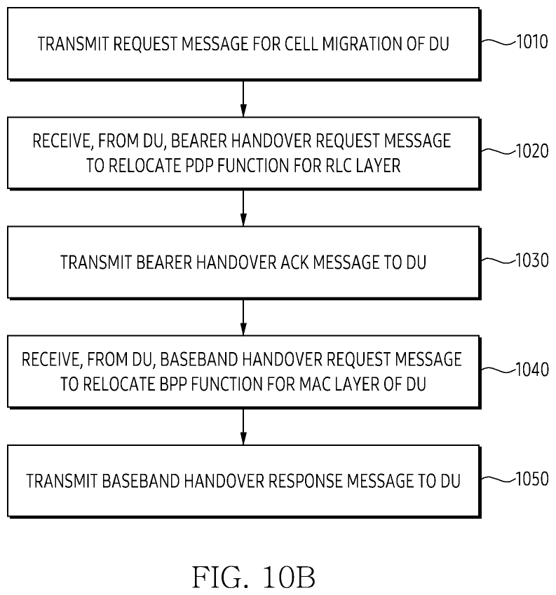

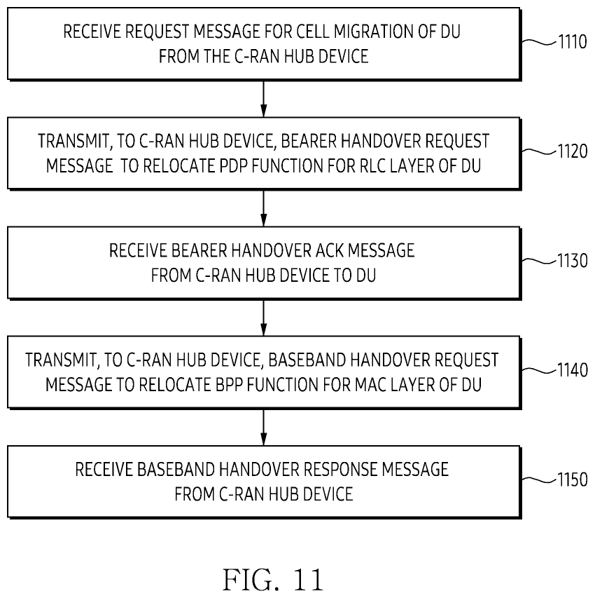

In FIGS. 10A, 10B, and 11, an operation for function transfer for a cell of a DU may be described. The function transfer for a cell may mean cell migration as described above.

FIG. 10A is a flowchart illustrating an operation of a C-RAN hub device according to an embodiment of the disclosure.

Operations 1005 to 1009 of FIG. 10A may relate to an operation for performing function transfer for a cell of a DU connected to a C-RAN hub device. The function transfer for the cell of the DU included in the C-RAN hub device may also be performed based on an operation similar to operations 1005 to 1009 of FIG. 10A.

For example, the C-RAN hub device may include a cell orchestrating pod (COP), a centralized unit (CU), a RAN managing pod (RMP), a packet distributing pod (PDP), and a baseband processing pod (BPP). The DU connected to the C-RAN hub device may include an RMP, a PDP, and a BPP. For convenience of explanation, each of RMP, PDP, and BPP included in the C-RAN hub device may be referred to as a target RMP, a target PDP, and a target BPP. Each of RMP, PDP, and BPP included in the DU may be referred to as a source RMP, a source PDP, and a source BPP.

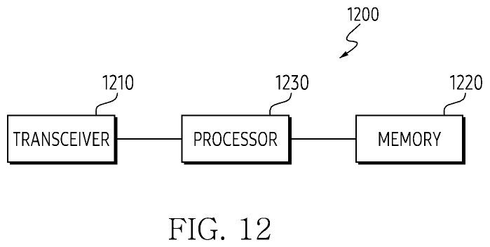

In operation 1005, a processor (e.g., the processor 1230 of FIG. 12) of the C-RAN hub device (hereinafter, processor) may receive a request message for function transfer for a cell of the DU connected to the C-RAN hub device. For example, the request message for function transfer for the cell of the DU may be referred to as a cell migration (CM) request message.

In operation 1007, the processor may relocate at least one of a PDP function for an RLC layer of the DU or a BPP function for a MAC layer to the C-RAN hub device. The processor may relocate at least one of a plurality of functions of the DU to the C-RAN hub device. For example, the processor may relocate at least one of the PDP function or the BPP function among the plurality of functions of the DU to the C-RAN hub device.

For example, when the PDP function of the DU is relocated to the C-RAN hub device, the processor may perform the PDP function of the DU on behalf of the DU. The processor may relocate the PDP function to the C-RAN hub device by transferring context information for bearers related to the cell.

For example, when the BPP function of the DU is relocated to the C-RAN hub device, the processor may perform the BPP function of the DU on behalf of the DU. The processor may relocate the BPP function to the C-RAN hub device by transferring context information for bearers related to the cell.

In operation 1009, the processor may perform at least one of the PDP function or the BPP function of the DU.

For example, after the PDP function is transferred to the C-RAN hub device, the PDP function for the RLC layer for the cell in the DU may be stopped. After the PDP function is transferred to the C-RAN hub device, the processor may perform the PDP function for the RLC layer for the cell.

For example, after the BPP function is transferred to the C-RAN hub device, the BPP function for the MAC layer for the cell in the DU may be stopped. After the BPP function is transferred to the C-RAN hub device, the processor may perform the BPP function for the MAC layer for the cell.

According to an embodiment, when a load for the cell of the DU exceeds a reference range, a function transfer for the cell of the DU may be performed. As the function for the cell of the DU is performed in the C-RAN hub device, an investment cost for networks may be reduced.

A specific operation performed in the C-RAN hub device to perform operations 1005 to 1009 of FIG. 10A will be described later in FIG. 10B.

FIG. 10B is a flowchart illustrating an operation of a C-RAN hub device according to an embodiment of the disclosure.

Operations 1010 to 1050 of FIG. 10B may relate to an operation for performing function transfer for the cell of the DU connected to the C-RAN hub device. Based on an operation similar to operations 1010 to 1050 of FIG. 10B, function transfer for the cell of the DU included in the C-RAN hub device may also be performed.

For example, the C-RAN hub device may include a cell orchestrating pod (COP), a centralized unit (CU), a RAN managing pod (RMP), a packet distributing pod (PDP), and a baseband processing pod (BPP). The DU connected to the C-RAN hub device may include an RMP, a PDP, and a BPP. For convenience of explanation, each of the RMP, PDP, and BPP included in the C-RAN hub device may be referred to as a target RMP, a target PDP, and a target BPP. Each of the RMP, PDP, and BPP included in the DU may be referred to as a source RMP, a source PDP, and a source BPP.

Referring to FIG. 10B, in operation 1010, a processor (e.g., the processor 1230 of FIG. 12) of the C-RAN hub device (hereinafter, processor) may transmit a request message for function transfer to the cell of the DU. For example, a request message for function transfer to the cell of the DU may be referred to as a cell migration (CM) request message.

The processor may receive cell load information from the DU. For example, the processor may receive cell load information from at least one DU connected to the C-RAN hub device. The processor may determine function transfer for the cell of the DU, based on the cell load information. The processor may check available resources of the target RMP using the COP. The processor may transmit an available resource ack message to the target RMP using the COP and may check the available resources of the target RMP based on receiving the available resource report message to the target RMP.

Based on checking the available resources of the target RMP, the processor may perform function transfer preparation for the cell through the target RMP. For example, the processor may transmit a function transfer preparation request message for the cell to the target RMP through the COP, and perform function transfer preparation for the cell based on receiving a function transfer preparation complete message for the cell from the target RMP.

As an example, the processor may transmit a CM-BB preparation request message to the target BPP through the target RMP, based on receiving a cell preparation request message from the COP. The processor may transmit a CM-PDP preparation request message to the target PDP through the target BPP. The processor may transmit a CM-PDP preparation response message to the target BPP through the target PDP. The processor may perform preparation for relocating the PDP function, based on the CM-PDP preparation request message and the CM-PDP preparation response message. The processor may transmit a CM-BB preparation response message to the target RMP through the target BPP. The processor may transmit a function transfer preparation completion message for the cell to the COP through the target RMP. The processor may perform preparation for relocating the BPP function, based on the CM-BB preparation request message and the CM-BB preparation response message.

For example, the processor may transmit a CM preparation request message to the target RMP through the COP. The processor may identify that there is no BPP or that it cannot accept function transfer for the cell even when there is a BPP. The processor may transmit a BPP creation request message to a service orchestrator (SO) through the RMP. The processor may receive a BPP creation response message from the SO through the target RMP. The processor may identify that the target BPP is created, based on the BPP creation request message and the BPP creation response message.

For example, a request message for function transfer to the cell may include cell identification information. The processor may identify a cell to be moved and transmit a request message for a function transfer for a cell including the cell identification information about a cell to be moved to the DU.

In operation 1020, the processor may receive, from the DU, a bearer handover request message to relocate a PDP function for a radio link control (RLC) layer. For example, the processor may receive the bearer handover request message from a source PDP of the DU, through the target PDP.

For example, the bearer handover request message may include context information for the RLC layer and cell identification information. The bearer handover request message may further include information about one or more bearers regarding the cell identification information. As an example, the information about one or more bearers may include GTP tunnel information with the CU. As an example, the RLC context information may include RLC-related information about one or more bearers.

For example, the processor may transmit a path switch request message to the CU through the target PDP, based on the bearer handover request message. The processor may transmit a path switch ack message to the target PDP through the CU.

In operation 1030, the processor may transmit a bearer handover ack message to the DU. The processor may relocate the PDP function based on the bearer handover ack message. The processor may relocate the PDP function from the source PDP of the DU to the target PDP of the C-RAN hub device, based on the bearer handover ack message.

For example, the bearer handover ack message may include a transport layer address so that the source PDP may forward the packet to the target PDP. While the PDP function is relocated, the processor may transmit an end marker packet to the DU through the CU. While the PDP function is relocated, the processor may receive the end marker packet of the CU from the DU. The processor may receive packets after the end marker packet from a user plane function (UPF) through the CU.

In operation 1040, the processor may receive, from the DU, a baseband handover request message to relocate a BPP function for a medium access control (MAC) layer of the DU. For example, the processor may receive the baseband handover request message from a source BPP of the DU through a target BPP.

For example, the baseband handover request message may include context information for the MAC layer and cell identification information. The processor may establish a MAC scheduling context for user equipment (UE) for a cell to be moved, through the target BPP. The processor may set up a connection for the target PDP and one or more bearers for the cell identification information through the target BPP.

In operation 1050, the processor may transmit a baseband handover response message to the DU. For example, the processor may transmit the baseband handover response message to the source BPP of the DU through the target BPP. Based on the baseband handover request message and the baseband handover response message, the processor may relocate the BPP function from the source BPP of the DU to the target PDP of the C-RAN hub device.

For example, the baseband handover request message may include information about a switchover time of the BPP function. The processor may transmit a path change request message to a radio unit (RU) associated with the cell identification information through the target BPP. The path change request message may include information about the switchover time of the BPP function. The processor may receive a path change ack message from the RU through the target BPP.

For example, the processor may identify the switchover time of the BPP function based on transmitting the baseband handover response message through the target BPP. The processor may schedule packets received from the UPF through the CU through the BPP function, based on the switchover time of the BPP function being elapsed. Before the switchover time of the BPP function is elapsed, scheduling for packets received from the UPF may be performed at the source BPP of the DU. After the switchover time of the BPP function is elapsed, scheduling for packets received from the UPF may be performed at the target BPP of the C-RAN hub device.

FIG. 11 is a flowchart illustrating an operation of a distributed unit (DU) according to an embodiment of the disclosure.

Operations 1110 to 1150 of FIG. 11 may relate to an operation for performing function transfer for a cell of a DU connected to a C-RAN hub device (e.g., the C-RAN Hub). Based on an operation similar to operations 1110 to 1150 of FIG. 11, function transfer for the cell of the DU included in the C-RAN hub device may also be performed.

For example, the DU may include a RAN managing pod (RMP), a packet distributing pod (PDP), and a baseband processing pod (BPP). The C-RAN hub device connected to the DU may include a cell orchestrating pod (COP), a centralized unit (CU), an RMP, a PDP, and a BPP. For convenience of explanation, each of the RMP, PDP, and BPP included in the C-RAN hub device may be referred to as a target RMP, a target PDP, and a target BPP. Each of the RMP, PDP, and BPP included in the DU may be referred to as a source RMP, a source PDP, and a source BPP.

Referring to FIG. 11, in operation 1110, a processor (e.g., the processor 1230 of FIG. 12) of the DU (hereinafter, processor) may receive a request message for function transfer for a cell of the DU. For example, the request message for function transfer for a cell of the DU may be referred to as a cell migration (CM) request message.

For example, the processor may transmit cell load information to the C-RAN hub device. The processor may transmit the cell load information to COP of the C-RAN hub device through the source RMP. The C-RAN hub device may determine function transfer for a cell of the DU, based on the cell load information. After the function transfer for the cell of the DU is determined, the processor may receive a request message for function transfer for a cell of the DU.

For example, the request message for function transfer to a cell may include cell identification information. The request message for function transfer to a cell, including cell identification information about a cell to be moved, may be received from the C-RAN hub device.

In operation 1120, the processor may transmit, to the C-RAN hub device, a bearer handover request message to relocate a PDP function for a radio link control (RLC) layer. For example, the processor may transmit the bearer handover request message to a target PDP of the C-RAN hub device through a source PDP.

For example, the bearer handover request message may include context information for the RLC layer and cell identification information. The bearer handover request message may further include information about one or more bearers regarding the cell identification information. As an example, the information about one or more bearers may include GTP tunnel information with the CU. As an example, the RLC context information may include RLC-related information about one or more bearers.

In operation 1130, the processor may receive a bearer handover ack message from the C-RAN hub device. Based on the bearer handover ack message, the processor may relocate the PDP function from the source PDP of the DU to the target PDP of the C-RAN hub device.

For example, the bearer handover ack message may include a transport layer address so that the source PDP may forward packets to the target PDP. While the PDP function is relocated, the processor may receive an end marker packet from the CU of the C-RAN hub device through the source PDP. While the PDP function is relocated, the processor may transmit the end marker packet of the CU to the C-RAN hub device. The processor may not receive packets after the end marker packet.

In operation 1140, the processor may transmit, to the C-RAN hub device, a baseband handover request message to relocate a BPP function for a medium access control (MAC) layer of the DU. For example, the processor may transmit the baseband handover request message to a target BPP of the C-RAN hub device through a source BPP. For example, the baseband handover request message may include context information for the MAC layer and cell identification information.

In operation 1150, the processor may receive a baseband handover response message from the C-RAN hub device. For example, the processor may receive a baseband handover response message from the target BPP of the C-RAN hub device through the source BPP. Based on the baseband handover request message and the baseband handover response message, the processor may relocate the BPP function from the source BPP of the DU to the target PDP of the C-RAN hub device. For example, the baseband handover request message may include information about a switchover time of the BPP function.

For example, the processor may identify the switchover time of the BPP function through the source BPP, based on receiving a baseband handover response message. The processor may schedule packets received from the CU of the C-RAN hub device through the BPP function before the switchover time of the BPP function is elapsed. Before the switchover time of the BPP function is elapsed, scheduling for the packets received from the UPF may be performed at the source BPP of the DU. After the switchover time of the BPP function is elapsed, scheduling for the packets received from the UPF may be performed at the target BPP of the C-RAN hub device.

FIG. 12 illustrates a functional configuration of an electronic device according to an embodiment of the disclosure.

The terms ‘ . . . unit’, ‘ . . . er’, and the like used below mean a unit processing at least one function or operation, which may be implemented by hardware or software, or a combination of hardware and software.

Referring to FIG. 12, an electronic device 1200 (e.g., DU or C-RAN hub device) may include a transceiver 1210, memory 1220, and a processor 1230. For example, the electronic device 1200 may be an example of the DU or the C-RAN hub device of the above-described embodiment. For example, the electronic device 1200 may be an example of blocks (e.g., RMP, PDP, or BPP) included in the DU and blocks (e.g., CU-CP, CU-UP, COP, RMP, PDP, or BPP) included in the C-RAN hub device.

The configuration of the electronic device 1200 illustrated in FIG. 12 is only an example, and examples of the electronic device 1200 performing embodiments of the disclosure are not limited to the configuration illustrated in FIG. 12. In some embodiments, some configuration may be added, deleted, or changed.

The processor 1230 may control the overall operations of the electronic device 1200. For example, the processor 1230 may write and read data in the memory 1220. For example, the processor 1230 may transmit and receive a signal through the transceiver 1210. Although one processor is illustrated in FIG. 12, the embodiments of the disclosure are not limited thereto. The electronic device 1200 may include at least one processor to perform embodiments of the disclosure. The processor 1230 may be referred to as a control unit or a control means. According to embodiments, the processor 1230 may control a device to perform operations of the electronic device 1200 according to the embodiments of the disclosure.

The memory 1220 may store data such as basic programs, application program, and setting information for operations of the electronic device 1200. The memory 1220 may be configured with volatile memory, nonvolatile memory, or a combination of volatile memory and nonvolatile memory. The memory 1220 may provide stored data, in accordance with a request of the processor 1230.

The transceiver 1210 may perform functions for transmitting and receiving a signal through a wireless channel. For example, the transceiver 1210 may perform a converting function between a baseband signal and a bit stream according to a physical layer specification of a system. For example, when transmitting data, the transceiver 1210 may generate complex symbols by encoding and modulating a transmission bit stream. When receiving data, the transceiver 1210 may restore a received bit stream by demodulating and decoding a baseband signal. The transceiver 1210 may upconvert a baseband signal into a radio frequency (RF) band signal and transmit it through an antenna, and down-convert an RF band signal received through an antenna into a baseband signal.

To this end, the transceiver 1210 may include a transmission filter, a reception filter, an amplifier, a mixer, an oscillator, a digital to analog convertor (DAC), an analog to digital convertor (ADC), and the like. The transceiver 1210 may include a plurality of transmission/reception paths. The transceiver 1210 may include at least one antenna array configured with a plurality of antenna elements. In terms of hardware, the transceiver 1210 may be configured with a digital unit and an analog unit, and the analog unit may be configured with a plurality of sub-units according to operating power, operating frequency, and the like.

The transceiver 1210 may transmit and receive a signal as described above. Accordingly, the transceiver 1210 may be referred to as ‘transmission unit’, ‘reception unit’, or ‘transmission/reception unit’. In addition, in the following description, transmission and reception performed through a wireless channel, a backhaul network, an optical cable, Ethernet, or other wired paths are used to mean that processing as described above is performed by the transceiver 1210. According to an embodiment, the transceiver 1210 may provide an interface for performing communication with other nodes in the network. That is, the transceiver 1210 may convert a bit stream transmitted from the electronic device 1200 to another node, for example, another access node, another base station, an upper node, a core network, and the like into a physical signal, and may convert a physical signal received from another node into a bit stream.

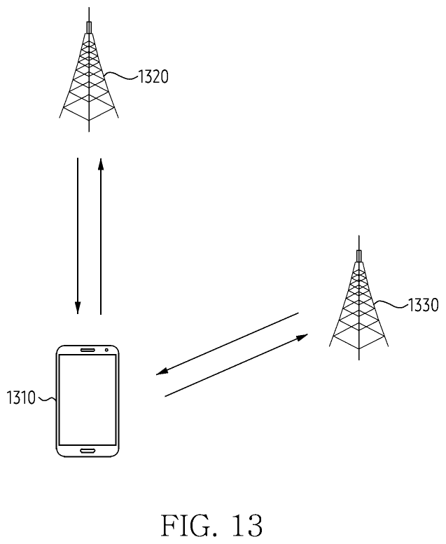

FIG. 13 illustrates a wireless communication system according to an embodiment of the disclosure.

Referring to FIG. 13, FIG. 13 illustrates a terminal 1310, a base station 1320, and a base station 1330 as some of nodes utilizing a wireless channel in a wireless communication system. The terminal 1310 may be connected to the base station 1320, to the second base station 1330, or to both the base station 1320 and the base station 1330.

The terminal 1310, which is a device used by a user, performs communication with the base station 1320 through a wireless channel. A link from the base station 1320 to the terminal 1310 is referred to as a downlink (DL), and a link from the terminal 1310 to the base station 1320 is referred to as an uplink (UL). In addition, although not illustrated in FIG. 13, the terminal 1310 and other terminals may perform communication through a wireless channel. At this time, a device-to-device link (D2D) between the terminal 1310 and other terminals is referred to as a sidelink, and the sidelink may be used interchangeably with PC5 interface. In some other embodiments, the terminal 1310 may be operated without the involvement of a user. According to an embodiment, the terminal 1310 may be a device performing machine type communication (MTC) and may not be carried by a user. In addition, according to an embodiment, the terminal 1310 may be a narrowband (NB)-internet of things (IoT) device. According to an embodiment, the terminal 1310 may operate as a RedCap UE. In addition to terminal, the terminal 1310 may also be referred to as a ‘user equipment (UE)’, a ‘customer premises equipment (CPE)’, a ‘mobile station’, a ‘subscriber station’, a ‘remote terminal’, a ‘wireless terminal’, an electronic device', or a ‘user device’ or other terms having an equivalent technical meaning.

The base station 1320 or base station 1330 is a network infrastructure that provides wireless access to the terminal 1310. The base station 1320 or base station 1330 has coverage defined based on a distance at which it may transmit a signal. According to an embodiment, the base station 1320 may provide an access network according to a 4G communication method (e.g., long term evolution (LTE)). The base station 1320 may provide one or more LTE cells. The base station 1320 may be referred to as an ‘access point (AP)’, ‘eNodeB (eNB)’, ‘wireless point’, ‘transmission/reception point (TRP)’ or other terms having equivalent technical meanings, in addition to base station. In addition, according to an embodiment, the base station 1330 may provide an access network according to a 5G communication method (e.g., new radio (NR)). The base station 1330 may provide one or more NR cells. The base station 1330 may be referred to as an ‘access point (AP)’, ‘next generation Node B (gNB)’, ‘5G Node B (5gNB)’, ‘wireless point’, ‘transmission/reception point (TRP)’ or other terms having equivalent technical meanings in addition to base station.

The base station 1320 or the base station 1330 may perform beamforming with the terminal 1310. For example, the base station 1330 and the terminal 1310 may transmit and receive a wireless signal in a relatively low frequency band (e.g., frequency range 1 (FR 1) of NR). In addition, the base station 1330 and the terminal 1310 may transmit and receive a wireless signal in a relatively high frequency band (e.g., FR 2 (or, FR 2-1, FR 2-2, FR 2-3) and FR 3 of NR, millimeter wave (mmWave) band (e.g., 28 GHz, 30 GHz, 38 GHz, 60 GHz)). In order to improve channel gain, the base station 1330 and the terminal 1310 may perform beamforming. Herein, the beamforming may include transmission beamforming and reception beamforming. The base station 1330 and the terminal 1310 may provide directionality to a transmission signal or a reception signal. To this end, the base station 1330 and the terminal 1310 may select serving beams through a beam search or beam management procedure. After the serving beams are selected, subsequent communications may be performed through resources that are in a quasi co-location (QCL) relationship with resources transmitting the serving beams.

If large-scale characteristics of a channel transferring a symbol on a first antenna port may be inferred from a channel transferring a symbol on a second antenna port, the first antenna port and the second antenna port may be evaluated to be in the QCL relationship. For example, the large-scale characteristics may include at least one of delay spread, Doppler spread, Doppler shift, average gain, average delay, and spatial receiver parameters.

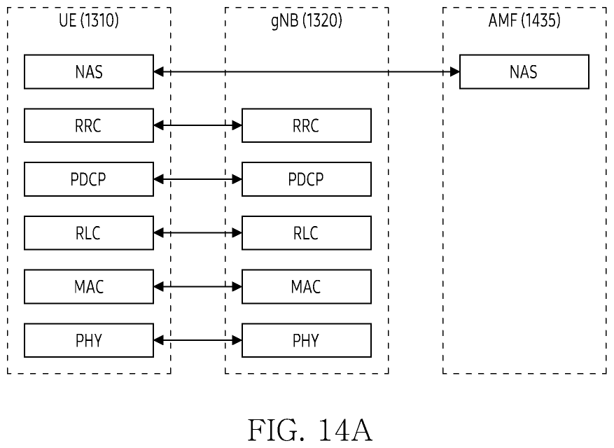

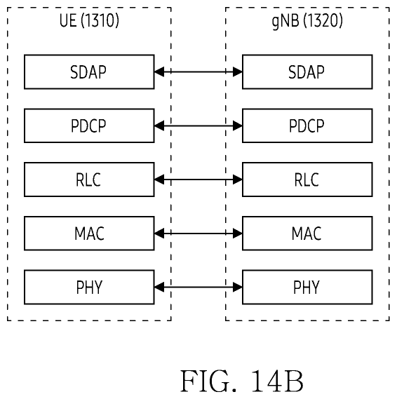

FIG. 14A illustrates an example of a control plane (C-plane) according to an embodiment of the disclosure.

In FIG. 14A, descriptions are given for each layer in the NR communication protocol, but at least a portion of the described descriptions may be equally applied to the LTE communication protocol between the terminal 1310 and the base station 1320.

Referring to FIG. 14A, in the C-plane, the terminal 1310 and the core network entity (e.g., access and mobility management entity (AMF) 1435) may perform non-access stratum (NAS) signaling. In the C-plane, the terminal 1310 and the base station 1330 may perform communication according to a protocol specified in each of a radio resource control (RRC) layer, a packet data convergence protocol (PDCP) layer, a radio link control (RLC) layer, a medium access control (MAC) layer, and a physical (PHY) layer.

The main functions of the RRC layer may include at least a portion of the following functions.
Broadcasting of system information related to access stratum (AS) and NAS
Paging initiated by a 5G core (5GC) or a next generation-radio access network (NG-RAN)
Establishment, maintenance, and release of RRC connection between the UE and the NG-RAN, including the following (a and b):
a. Addition, modification, and release of carrier aggregation
b. Addition, modification, and release of dual connectivity between NR and either E-UTRA or NR
Security functions including key management
Establishment, configuration, maintenance, and release of Signaling Radio Bearer (SRB) and Data Radio Bearer (DRB)
Movement functions including the following (a to c):
a. Handover and context transfer
b. UE cell selection and reselection, and control of cell selection and reselection
c. Mobility across RATs
Quality of service (QoS) management function
UE measurement reporting and control of the reporting
Detection and recovery of radio link failure
Transmission of messages from/to the NAS to/from the UE

The main functions of the PDCP layer may include at least a portion of the following functions.
Header compression and decompression (ROHC only)
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The main functions of the RLC layer may include at least a portion of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The MAC layer may be connected to a plurality of RLC layer devices configured in one terminal, and the main functions of the MAC may include at least a portion of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

The physical layer may include operations of channel-coding and modulating upper layer data to generate OFDM symbols and transmit them over a wireless channel, or operations of demodulating OFDM symbols received through the wireless channel and performing channel decoding to transfer them to an upper layer.

FIG. 14B illustrates an example of a user plane (U-plane) according to an embodiment of the disclosure.

In FIG. 14B, descriptions are given for each layer in the NR communication protocol, but at least a portion of the described descriptions may be equally applied to the LTE communication protocol between the terminal 1310 and the base station 1320.

Referring to FIG. 14B, in the U-plane, the terminal 1310 and the base station 1330 may perform communication according to a protocol specified in each of a service data adaptation protocol (SDAP) layer, the PDCP layer, the RLC layer, the MAC layer, and the PHY layer.

The SDAP layer may provide a QoS flow of 5GC. A single protocol entity of SDAP may be configured for each individual PDU session, and functions of the SDAP layer may include at least a portion of the following functions.
Mapping between QoS flows and data radio bearer
Indicate QoS flow identifier (ID) (QFI) in both DL and UL packets

According to an embodiment, a method performed by a centralized-radio access network (C-RAN) hub device in a wireless network system may comprise transmitting a request message for function transfer for a cell of a distributed unit (DU) connected to the C-RAN hub device. The method may comprise, based on the request message, relocating at least one of a packet distributing pod (PDP) function for a radio link control (RLC) layer or a baseband processing pod (BPP) function for a medium access control (MAC) layer, to the C-RAN hub device. The method may comprise, based on the relocation, performing at least one of the PDP function of the DU or the BPP function of the DU.

According to an embodiment, the method may comprise transmitting the request message including cell identification information. The method may comprise receiving, from the DU, a bearer handover request message for reallocating the PDP function for the RLC layer of the DU. The method may comprise transmitting, to the DU, a bearer handover acknowledgement message. The method may comprise receiving, from the DU, a baseband handover request message for reallocating the BPP function for the MAC layer of the DU. The method may comprise transmitting, to the DU, a baseband handover response message. The bearer handover request message may include context information on the RLC layer and the cell identification information. The baseband handover request message may include context information on the MAC layer and the cell identification information.

According to an embodiment, the bearer handover request message may include information on one more bearers associated with the cell identification information. The context information on the RLC layer may include RLC related information on the one or more bearers.

According to an embodiment, the method may comprise receiving, from the DU, an end marker packet of a centralized unit (CU) of the C-RAN hub device while the PDP function is being relocated. The method may comprise receiving, through the CU, packets after the end marker packet from a user plane function (UPF).

According to an embodiment, the baseband handover request message may include information on a switchover time of the BPP function. The method may comprise transmitting a path change request message to a radio unit (RU) related to the cell identification information., the path change request message including the information on the switchover time of the BPP function. The method may comprise receiving a path change acknowledgement message from the RU.

According to an embodiment, the method may comprise identifying the switchover time of the BPP function based on transmitting the baseband handover response message. The method may comprise, based on the switchover time of the BPP function being elapsed, scheduling, through the BPP function, packets received, through the CU, from a user plane function (UPF).

According to an embodiment, a method performed by a distributed unit (DU) may comprise receiving, from a centralized-radio access network (C-RAN) hub device connected to the DU, a request message for function transfer for a cell of the DU. The request message may include cell identification information. The method may comprise transmitting, to the C-RAN hub device, a bearer handover request message for relocating a packet distributing pod (PDP) function for a radio link control (RLC) layer of the DU. The method may comprise receiving a bearer handover acknowledgement message from the C-RAN hub device. The method may comprise transmitting, to the C-RAN hub device, a baseband handover request message for relocating a baseband processing pod (BPP) function for a medium access control (MAC) protocol of the DU. The method may comprise receiving, from the C-RAN hub device, a baseband handover response message. The bearer handover request message may include context information on the RLC layer and the cell identification information. The baseband handover request message may include context information on the MAC layer and the cell identification information.

According to an embodiment, the bearer handover request message may include information on one more bearers associated with the cell identification information. The context information on the RLC layer may include RLC related information on the one or more bearers.

According to an embodiment, the method may comprise receiving, from the C-RAN hub device, an end marker packet of a centralized unit (CU) of the C-RAN hub device while the PDP function is being relocated. The method may comprise transmitting, to the C-RAN hub device, the end marker packet of the CU of the C-RAN hub device.

According to an embodiment, the baseband handover request message may include information on a switchover time of the BPP function.

According to an embodiment, the method may comprise identifying a switchover time of the BPP function based on receiving the baseband handover response message. The method may comprise scheduling, through the BPP function, packets received from a centralized unit (CU) of the C-RAN hub device before the switchover time of the BBP function is elapsed.

According to an embodiment, a centralized-radio access network (C-RAN) hub device in a wireless network system may comprise memory, a transceiver, and at least one processor. The at least one processor may be configured to transmit a request message for function transfer for a cell of a distributed unit (DU) connected to the C-RAN hub device. The at least one processor may be configured to, based on the request message for function transfer for the cell, relocate at least one of a packet distributing pod (PDP) function for a radio link control (RLC) layer or a baseband processing pod (BPP) function for a medium access control (MAC) layer, to the C-RAN hub device. The at least one processor may be configured to, based on the relocation, perform at least one of the PDP function of the DU or the BPP function of the DU.

According to an embodiment, the at least one processor may be configured to transmit the request message including cell identification information. The at least one processor may be configured to receive, from the DU, a bearer handover request message for reallocating the PDP function for the RLC layer of the DU. The at least one processor may be configured to transmit, to the DU, a bearer handover acknowledgement message. The at least one processor may be configured to receive, from the DU, a baseband handover request message for reallocating the BPP function for the MAC layer of the DU. The at least one processor may be configured to transmit, to the DU, a baseband handover response message. The bearer handover request message may include context information on the RLC layer and the cell identification information. The baseband handover request message may include context information on the MAC layer and the cell identification information.

According to an embodiment, the bearer handover request message may include information on one more bearers associated with the cell identification information. The context information on the RLC layer may include RLC related information on the one or more bearers.

According to an embodiment, the at least one processor may be configured to receive, from the DU, an end marker packet of a centralized unit (CU) of the C-RAN hub device while the PDP function is being relocated. The at least one processor may be configured to receive, through the CU, packets after the end marker packet from a user plane function (UPF).

According to an embodiment, the baseband handover request message may include information on a switchover time of the BPP function. The at least one processor may be configured to transmit a path change request message to a radio unit (RU) related to the cell identification information. The path change request message may include the information on the switchover time of the BPP function. The at least one processor may be configured to receive a path change acknowledgement message from the RU.

According to an embodiment, the at least one processor may be configured to identify the switchover time of the BPP function based on transmitting the baseband handover response message. The at least one processor may be configured to, based on the switchover time of the BPP function being elapsed, schedule, through the BPP function, packets received, through the CU, from a user plane function (UPF).

According to an embodiment, an electronic device performed by a distributed unit (DU) in a wireless network system may comprise memory, a transceiver, and at least one processor. The at least one processor may be configured to receive, from a centralized-radio access network (C-RAN) hub device connected to the DU, a request message for function transfer for a cell of the DU. The request message may include cell identification information. The at least one processor may be configured to transmit, to the C-RAN hub device, a bearer handover request message for relocating a packet distributing pod (PDP) function for a radio link control (RLC) layer of the DU. The at least one processor may be configured to receive a bearer handover acknowledgement message from the C-RAN hub device. The at least one processor may be configured to transmit, to the C-RAN hub device, a baseband handover request message for relocating a baseband processing pod (BPP) function for a medium access control (MAC) protocol of the DU. The at least one processor may be configured to receive, from the C-RAN hub device, a baseband handover response message. The bearer handover request message may include context information on the RLC layer and the cell identification information. The baseband handover request message may include context information on the MAC layer and the cell identification information.

According to an embodiment, the bearer handover request message may include information on one more bearers associated with the cell identification information. The context information on the RLC layer may include RLC related information on the one or more bearers.

According to an embodiment, the at least one processor may be configured to receive, from the C-RAN hub device, an end marker packet of a centralized unit (CU) of the C-RAN hub device while the PDP function is being relocated. The at least one processor may be configured to transmit, to the C-RAN hub device, the end marker packet of the CU of the C-RAN hub device.

According to an embodiment, the baseband handover request message may include information on a switchover time of the BPP function.

According to an embodiment, the at least one processor may be configured to identify a switchover time of the BPP function based on receiving the baseband handover response message. The at least one processor may be configured to schedule, through the BPP function, packets received from a centralized unit (CU) of the C-RAN hub device before the switchover time of the BBP function is elapsed.

According to an embodiment, a non-transitory computer readable storage media may include memory storing programs including instruction. The instructions, when executed by a processor, may cause to perform one of methods performed by the centralized-radio access network (C-RAN) or perform one of methods performed by a distributed unit (DU).

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a centralized-radio access network (C-RAN) hub device in a wireless network system, the method comprising:
transmitting a request message for function transfer for a cell of a distributed unit (DU) connected to the C-RAN hub device;
based on the request message, relocating at least one of a packet distributing pod (PDP) function for a radio link control (RLC) layer or a baseband processing pod (BPP) function for a medium access control (MAC) layer, to the C-RAN hub device; and
based on the relocation, performing at least one of the PDP function of the DU or the BPP function of the DU.

2. The method of claim 1, further comprising:
transmitting the request message including cell identification information;
receiving, from the DU, a bearer handover request message for reallocating the PDP function for the RLC layer of the DU;
transmitting, to the DU, a bearer handover acknowledgement message;
receiving, from the DU, a baseband handover request message for reallocating the BPP function for the MAC layer of the DU; and
transmitting, to the DU, a baseband handover response message,
wherein the bearer handover request message includes context information on the RLC layer and the cell identification information, and
wherein the baseband handover request message includes context information on the MAC layer and the cell identification information.

3. The method of claim 2,
wherein the bearer handover request message further includes information on one more bearers associated with the cell identification information, and
wherein the context information on the RLC layer includes RLC related information on the one or more bearers.

4. The method of claim 2, further comprising:
receiving, from the DU, an end marker packet of a centralized unit (CU) of the C-RAN hub device while the PDP function is being relocated; and
receiving, through the CU, packets after the end marker packet from a user plane function (UPF).

5. The method of claim 4,
wherein the baseband handover request message further includes information on a switchover time of the BPP function, and
wherein the method further comprises:
transmitting a path change request message to a radio unit (RU) related to the cell identification information, the path change request message including the information on the switchover time of the BPP function, and
receiving a path change acknowledgement message from the RU.

6. The method of claim 5, further comprising:
identifying the switchover time of the BPP function based on transmitting the baseband handover response message; and
based on the switchover time of the BPP function being elapsed, scheduling, through the BPP function, packets received, through the CU, from a user plane function (UPF).

7. A method performed by a distributed unit (DU), the method comprising:
receiving, from a centralized-radio access network (C-RAN) hub device connected to the DU, a request message for function transfer for a cell of the DU, wherein the request message includes cell identification information;
transmitting, to the C-RAN hub device, a bearer handover request message for relocating a packet distributing pod (PDP) function for a radio link control (RLC) layer of the DU;
receiving a bearer handover acknowledgement message from the C-RAN hub device;
transmitting, to the C-RAN hub device, a baseband handover request message for relocating a baseband processing pod (BPP) function for a medium access control (MAC) protocol of the DU; and
receiving, from the C-RAN hub device, a baseband handover response message,
wherein the bearer handover request message includes context information on the RLC layer and the cell identification information, and
wherein the baseband handover request message includes context information on a MAC layer and the cell identification information.

8. The method of claim 7,
wherein the bearer handover request message further includes information on one more bearers associated with the cell identification information, and
wherein the context information on the RLC layer includes RLC related information on the one or more bearers.

9. The method of claim 7, further comprising:
receiving, from the C-RAN hub device, an end marker packet of a centralized unit (CU) of the C-RAN hub device while the PDP function is being relocated; and
transmitting, to the C-RAN hub device, the end marker packet of the CU of the C-RAN hub device.

10. The method of claim 7, wherein the baseband handover request message further includes information on a switchover time of the BPP function.

11. A centralized-radio access network (C-RAN) hub device in a wireless network system, the C-RAN hub device comprising:
memory, including one or more storage media, storing instructions;
a transceiver; and
at least one processor including processing circuitry,
wherein the instructions, when executed by the at least one processor, individually or collectively, cause the C-RAN hub device to:
transmit a request message for function transfer for a cell of a distributed unit (DU) connected to the C-RAN hub device,
based on the request message for function transfer for the cell, relocate at least one of a packet distributing pod (PDP) function for a radio link control (RLC) layer or a baseband processing pod (BPP) function for a medium access control (MAC) layer, to the C-RAN hub device, and
based on the relocation, perform at least one of the PDP function of the DU or the BPP function of the DU.

12. The C-RAN hub device of claim 11, wherein the instructions, when executed by the at least one processor, individually or collectively, cause the C-RAN hub device to:
transmit the request message including cell identification information;
receive, from the DU, a bearer handover request message for reallocating the PDP function for the RLC layer of the DU;
transmit, to the DU, a bearer handover acknowledgement message;
receive, from the DU, a baseband handover request message for reallocating the BPP function for the MAC layer of the DU; and
transmit, to the DU, a baseband handover response message,
wherein the bearer handover request message includes context information on the RLC layer and the cell identification information, and
wherein the baseband handover request message includes context information on the MAC layer and the cell identification information.

13. The C-RAN hub device of claim 12,
wherein the bearer handover request message further includes information on one more bearers associated with the cell identification information, and
wherein the context information on the RLC layer includes RLC related information on the one or more bearers.

14. The C-RAN hub device of claim 12, wherein the instructions, when executed by the at least one processor, individually or collectively, cause the C-RAN hub device to:
receive, from the DU, an end marker packet of a centralized unit (CU) of the C-RAN hub device while the PDP function is being relocated; and
receive, through the CU, packets after the end marker packet from a user plane function (UPF).

15. The C-RAN hub device of claim 14,
wherein the baseband handover request message further includes information on a switchover time of the BPP function, and
wherein the instructions, when executed by the at least one processor, individually or collectively, cause the C-RAN hub device to:
transmit a path change request message to a radio unit (RU) related to the cell identification information, the path change request message including the information on the switchover time of the BPP function, and
receive a path change acknowledgement message from the RU.

16. The C-RAN hub device of claim 15,
identify the switchover time of the BPP function based on transmitting the baseband handover response message; and
based on the switchover time of the BPP function being elapsed, schedule, through the BPP function, packets received, through the CU, from a user plane function (UPF).

17. An electronic device performed by a distributed unit (DU) in a wireless network system, the electronic device comprising:
memory, including one or more storage media, storing instructions;
a transceiver; and
at least one processor including processing circuitry,
wherein the instructions, when executed by the at least one processor, individually or collectively, cause the electronic device to:
receive, from a centralized-radio access network (C-RAN) hub device connected to the DU, a request message for function transfer for a cell of the DU, wherein the request message includes cell identification information,
transmit, to the C-RAN hub device, a bearer handover request message for relocating a packet distributing pod (PDP) function for a radio link control (RLC) layer of the DU,
receive a bearer handover acknowledgement message from the C-RAN hub device,
transmit, to the C-RAN hub device, a baseband handover request message for relocating a baseband processing pod (BPP) function for a medium access control (MAC) protocol of the DU, and
receive, from the C-RAN hub device, a baseband handover response message,
wherein the bearer handover request message includes context information on the RLC layer and the cell identification information, and
wherein the baseband handover request message includes context information on a MAC layer and the cell identification information.

18. The electronic device of claim 17,
wherein the bearer handover request message further includes information on one more bearers associated with the cell identification information, and
wherein the context information on the RLC layer includes RLC related information on the one or more bearers.

19. The electronic device of claim 17, wherein the instructions, when executed by the at least one processor, individually or collectively, cause the electronic device to:
receive, from the C-RAN hub device, an end marker packet of a centralized unit (CU) of the C-RAN hub device while the PDP function is being relocated; and
transmit, to the C-RAN hub device, the end marker packet of the CU of the C-RAN hub device.

20. The electronic device of claim 17, wherein the baseband handover request message further includes information on a switchover time of the BPP function.
